(19) United States
(12) Patent Application Publication
(10) Pub. No.: US 2026/0129512 A1
(43) Pub. Date: May 7, 2026

(54) DATA PACKET DISCARD REDUCTION FOR HANDOVER PROCEDURES

(71) Applicant: QUALCOMM Incorporated, San Diego, CA (US)

(72) Inventors: Ming YANG, San Diego, CA (US); Kausik RAY CHAUDHURI, San Diego, CA (US); Juan MONTOJO, San Diego, CA (US)

(21) Appl. No.: 18/939,039

(22) Filed: Nov. 6, 2024

(51) Int. Cl. H04W 28/06; H04W 36/24

(52) U.S. Cl. CPC H04W 28/06; H04W 36/249

(57) ABSTRACT

Various aspects of the present disclosure generally relate to wireless communication. A user equipment (UE) may receive, from a source network node, information associated with a handover from the source network node to a target network node. The UE may transmit, to the target network node after the handover from the source network node to the target network node, information associated with a protocol data unit (PDU) in a set of PDUs scheduled for transmission to the UE based on a timer associated with the PDU and a request for the target network node to discard a first subset PDUs of the set of PDUs based on the information associated with the PDU. The UE may receive, from the target network node, a second subset of PDUs of the set of PDUs based at least in part on the information. Numerous other aspects are described.

### FIELD OF THE DISCLOSURE

Aspects of the present disclosure generally relate to wireless communication and specifically relate to techniques, apparatuses, and methods associated with packet discard reduction for handover procedures.

### BACKGROUND

Wireless communication systems are widely deployed to provide various services, which may involve carrying or supporting voice, text, other messaging, video, data, and/or other traffic. Typical wireless communication systems may employ multiple-access radio access technologies (RATs) capable of supporting communication among multiple wireless communication devices including user devices or other devices by sharing the available system resources (for example, time domain resources, frequency domain resources, spatial domain resources, and/or device transmit power, among other examples). Such multiple-access RATs are supported by technological advancements that have been adopted in various telecommunication standards, which define common protocols that enable different wireless communication devices to communicate on a local, municipal, national, regional, or global level.

An example telecommunication standard is New Radio (NR). NR, which may also be referred to as 5G, is part of a continuous mobile broadband evolution promulgated by the Third Generation Partnership Project (3GPP). NR (and other RATs beyond NR) may be designed to better support enhanced mobile broadband (eL3) access, Internet of things (IoT) networks or reduced capability device deployments, and ultra-reliable low latency communication (URLLC) applications. To support these verticals, NR systems may be designed to implement a modularized functional infrastructure, a disaggregated and service-based network architecture, network function virtualization, network slicing, multi-access edge computing, millimeter wave (mmWave) technologies including massive multiple-input multiple-output (MIMO), licensed and unlicensed spectrum access, non-terrestrial network (NTN) deployments, sidelink and other device-to-device direct communication technologies (for example, cellular vehicle-to-everything (CV2X) communication), multiple-subscriber implementations, high-precision positioning, and/or radio frequency (RF) sensing, among other examples. As the demand for connectivity continues to increase, further improvements in NR may be implemented, and other RATs, such as 6G and beyond, may be introduced to enable new applications and facilitate new use cases.

### SUMMARY

Some aspects described herein relate to a user equipment (UE) for wireless communication. The UE may include one or more memories and one or more processors coupled to the one or more memories. The one or more processors may be configured to receive, from a source network node, information associated with a handover from the source network node to a target network node. The one or more processors may be configured to transmit, to the target network node after the handover from the source network node to the target network node, information associated with a protocol data unit (PDU) in a set of PDUs scheduled for transmission to the UE based at least in part on a timer associated with the PDU and a request for the target network node to discard a first subset PDUs of the set of PDUs based at least in part on the information associated with the PDU. The one or more processors may be configured to receive, from the target network node, a second subset of PDUs of the set of PDUs based at least in part on the information.

Some aspects described herein relate to a target network node for wireless communication. The target network node may include one or more memories and one or more processors coupled to the one or more memories. The one or more processors may be configured to receive, from a source network node, an indication of a set of PDUs scheduled for transmission to a UE. The one or more processors may be configured to receive, from the UE after handover of the UE from the source network node to the target network node, information associated with a PDU in the set of PDUs scheduled for transmission to the UE based at least in part on a timer associated with the PDU and a request to discard a first subset PDUs of the set of PDUs based at least in part on the information. The one or more processors may be configured to transmit, to the UE, a second subset of PDUs of the set of PDUs based at least in part on the information.

Some aspects described herein relate to a method of wireless communication performed by a UE. The method may include receiving, from a source network node, information associated with a handover from the source network node to a target network node. The method may include transmitting, to the target network node after the handover from the source network node to the target network node, information associated with a PDU in a set of PDUs scheduled for transmission to the UE based at least in part on a timer associated with the PDU and a request for the target network node to discard a first subset PDUs of the set of PDUs based at least in part on the information associated with the PDU. The method may include receiving, from the target network node, a second subset of PDUs of the set of PDUs based at least in part on the information.

Some aspects described herein relate to a method of wireless communication performed by a target network node. The method may include receiving, from a source network node, an indication of a set of PDUs scheduled for transmission to a UE. The method may include receiving, from the UE after handover of the UE from the source network node to the target network node, information associated with a PDU in the set of PDUs scheduled for transmission to the UE based at least in part on a timer associated with the PDU and a request to discard a first subset PDUs of the set of PDUs based at least in part on the information. The method may include transmitting, to the UE, a second subset of PDUs of the set of PDUs based at least in part on the information.

Some aspects described herein relate to a non-transitory computer-readable medium that stores a set of instructions for wireless communication by a UE. The set of instructions, when executed by one or more processors of the UE, may cause the UE to receive, from a source network node, information associated with a handover from the source network node to a target network node. The set of instructions, when executed by one or more processors of the UE, may cause the UE to transmit, to the target network node after the handover from the source network node to the target network node, information associated with a PDU in a set of PDUs scheduled for transmission to the UE based at least in part on a timer associated with the PDU and a request for the target network node to discard a first subset PDUs of the set of PDUs based at least in part on the information associated with the PDU. The set of instructions, when executed by one or more processors of the UE, may cause the UE to receive, from the target network node, a second subset of PDUs of the set of PDUs based at least in part on the information.

Some aspects described herein relate to a non-transitory computer-readable medium that stores a set of instructions for wireless communication by a target network node. The set of instructions, when executed by one or more processors of the target network node, may cause the target network node to receive, from a source network node, an indication of a set of PDUs scheduled for transmission to a UE. The set of instructions, when executed by one or more processors of the target network node, may cause the target network node to receive, from the UE after handover of the UE from the source network node to the target network node, information associated with a PDU in the set of PDUs scheduled for transmission to the UE based at least in part on a timer associated with the PDU and a request to discard a first subset PDUs of the set of PDUs based at least in part on the information. The set of instructions, when executed by one or more processors of the target network node, may cause the target network node to transmit, to the UE, a second subset of PDUs of the set of PDUs based at least in part on the information.

Some aspects described herein relate to an apparatus for wireless communication. The apparatus may include means for receiving, from a source network node, information associated with a handover from a source network node to a target network node. The apparatus may include means for transmitting, to the target network node after the handover from the source network node to the target network node, information associated with a PDU in a set of PDUs scheduled for transmission to a UE based at least in part on a timer associated with the PDU and a request for the target network node to discard a first subset PDUs of the set of PDUs based at least in part on the information associated with the PDU. The apparatus may include means for receiving, from the target network node, a second subset of PDUs of the set of PDUs based at least in part on the information.

Some aspects described herein relate to an apparatus for wireless communication. The apparatus may include means for receiving, from a source network node, an indication of a set of PDUs scheduled for transmission to a UE. The apparatus may include means for receiving, from the UE after handover of the UE from the source network node to a target network node, information associated with a PDU in the set of PDUs scheduled for transmission to the UE based at least in part on a timer associated with the PDU and a request to discard a first subset PDUs of the set of PDUs based at least in part on the information. The apparatus may include means for transmitting, to the UE, a second subset of PDUs of the set of PDUs based at least in part on the information.

Aspects of the present disclosure may generally be implemented by or as a method, apparatus, system, computer program product, non-transitory computer-readable medium, user equipment, base station, network node, network entity, wireless communication device, and/or processing system as substantially described with reference to, and as illustrated by, this specification and accompanying drawings.

The foregoing paragraphs of this section have broadly summarized some aspects of the present disclosure. These and additional aspects and associated advantages will be described hereinafter. The disclosed aspects may be used as a basis for modifying or designing other aspects for carrying out the same or similar purposes of the present disclosure. Such equivalent aspects do not depart from the scope of the appended claims. Characteristics of the aspects disclosed herein, both their organization and method of operation, together with associated advantages, will be better understood from the following description when considered in connection with the accompanying drawings.

### BRIEF DESCRIPTION OF THE DRAWINGS

The appended drawings illustrate some aspects of the present disclosure but are not limiting of the scope of the present disclosure because the description may enable other aspects. Each of the drawings is provided for purposes of illustration and description, and not as a definition of the limits of the claims. The same or similar reference numbers in different drawings may identify the same or similar elements.

FIG. 1 is a diagram illustrating an example of a wireless communication network, in accordance with the present disclosure.

FIG. 2 is a diagram illustrating an example disaggregated network node architecture, in accordance with the present disclosure.

FIG. 3 is a diagram illustrating an example of a layer 3 handover procedure, in accordance with the present disclosure.

FIG. 4 is a diagram illustrating an example of a conditional handover procedure, in accordance with the present disclosure.

FIG. 5 is a diagram illustrating an example of a layer 1 or layer 2 triggered mobility procedure, in accordance with the present disclosure.

FIG. 6 is a diagram illustrating an example associated with a user equipment (UE) discarding expired data packets after handover, in accordance with the present disclosure.

FIG. 7 is a diagram illustrating an example of reducing discarded data packets after handover in accordance with the present disclosure.

FIG. 8 is a diagram illustrating an example process performed, for example, at an UE or an apparatus of an UE, in accordance with the present disclosure.

FIG. 9 is a diagram illustrating an example process performed, for example, at a target network node or an apparatus of a target network node, in accordance with the present disclosure.

FIG. 10 is a diagram of an example apparatus for wireless communication, in accordance with the present disclosure.

FIG. 11 is a diagram of an example apparatus for wireless communication, in accordance with the present disclosure.

### DETAILED DESCRIPTION

Various aspects of the present disclosure are described hereinafter with reference to the accompanying drawings. However, aspects of the present disclosure may be embodied in many different forms. The present disclosure is not to be construed as limited to any specific aspect illustrated by or described with reference to an accompanying drawing or otherwise presented in this disclosure. Rather, these aspects are provided so that this disclosure will be thorough and complete, and will fully convey the scope of the disclosure to those skilled in the art. One skilled in the art may appreciate that the scope of the disclosure is intended to cover any aspect of the disclosure disclosed herein, whether implemented independently of or in combination with any other aspect of the disclosure. For example, an apparatus may be implemented or a method may be practiced using various combinations or quantities of the aspects set forth herein. In addition, the scope of the disclosure is intended to cover an apparatus having, or a method that is practiced using, other structures and/or functionalities in addition to or other than the structures and/or functionalities with which various aspects of the disclosure set forth herein may be practiced. Any aspect of the disclosure disclosed herein may be embodied by one or more elements of a claim.

Several aspects of telecommunication systems will now be presented with reference to various methods, operations, apparatuses, and techniques. These methods, operations, apparatuses, and techniques will be described in the following detailed description and illustrated in the accompanying drawings by various blocks, modules, components, circuits, steps, processes, or algorithms (collectively referred to as “elements”). These elements may be implemented using hardware, software, or a combination of hardware and software. Whether such elements are implemented as hardware or software depends upon the particular application and design constraints imposed on the overall system.

In some examples of wireless communication networks, a user equipment (UE) may communicate with a source network node. For example, the source network node may transmit protocol data units (PDUs) to the UE in accordance with a packet data convergence protocol (PDCP). In some examples, the UE may receive and store one or more PDUs received from the source network node in a delay buffer. For example, the UE may use the delay buffer to manage variations in the arrival times of PDUs received from the source network node, also known as jitter, ensuring smooth and continuous playback of data in a sequenced order. In accordance with real-time communication services, PDUs may be associated with a low latency metric such that delays, jitter, or packet loss may result in choppy or distorted data processing. Therefore, the delay buffer may hold PDUs received from the source network node for a duration to allow for any delayed packets to arrive and be processed in an ordered sequence.

By using the delay buffer, the UE may wait a duration to receive one or more PDUs to ensure that the one or more PDUs are in order for execution at the UE. For example, each PDU in a set of PDUs may be associated with sequence number associated with ordering the data of the set of PDUs in a configured order for sequenced playback at the UE. Therefore, if the UE receives a first PDU with a higher sequence number before receiving a second PDU with a lower sequence number, the UE may use the delay buffer to wait for the second PDU to arrive and then execute the second PDU before the first PDU in accordance with the ordering the sequence numbers. In some examples, the duration that the UE waits for a PDU associated with a given sequence number may be based on a timer associated with a PDU stored at the delay buffer. For example, the UE may initiate the timer in accordance with receiving a PDU. If the UE is able to receive order the sequence of PDUs in accordance with the associated sequence numbers prior to expiration of the timer, then the UE may process the sequence of PDUs in accordance with the sequence order. If, however, the timer expires without the UE receiving and/or reordering the sequence of PDUs or the sequence of PDUs arrives after the timer expires, the UE may be unable to process the sequence of PDUs without distortions to the data processing. Therefore, the timer may enable a balance between reducing delay for PDU processing at the UE and preventing PDU loss.

Additionally, the UE may operate in accordance with a handover procedure. For example, the UE may establish a wireless link with a target network node in accordance with one or more types of handover procedures (e.g., layer 3 (L3) handover, conditional handover (CHO), or layer 1 (L1) or layer 2 (L2) triggered mobility (LTM) procedure). In accordance with a successful handover of the UE from the source network node to the target network node, the source network node may forward one or more PDUs, scheduled for transmission to the UE, to the target network node. However, the handover procedure may cause a data interruption during which the UE does not receive any PDUs from the source network node or the target network node. For example, there may be latency associated with performing the handover to the target network node and establishing a wireless link (e.g., based on a time for the UE to apply a configuration for the target network node and/or perform uplink and/or downlink synchronization). Additionally, there may be latency associated with the source network node forwarding the one or more of PDUs to the target network node. In some examples, delay of one or more PDUs may disrupt the flow of the UE processing PDUs stored at the delay buffer. For example, if the timer associated with the PDU stored in the delay buffer expires before reception of the one or more PDUs, the UE may be unable to process the one or more PDUs. Despite the timer expiration, the target network node may still transmit the one or more PDUs and the UE may still receive the one or more PDUs after the handover, which may consume network resources, cause interference in the network and/or at the UE, consume power at the UE, and/or degrade a user experience at the UE. Additionally, prior to transmission of the set of PDUs, the target network node may process the one or more PDUs. Therefore, processing PDUs that the UE may discard may increase a duration of the data interruption associated with performing the handover procedure.

Various aspects relate generally to reducing the number of PDUs that are discarded at a UE after a handover. Some aspects more specifically relate to the UE transmitting, to the target network node, timing information associated with a PDU in a set of PDUs that is stored at the delay buffer of the UE. For example, the timing information may indicate a state of a timer associated with a PDU stored at the UE and a sequence number of the PDU stored at the UE. Additionally, the UE may request for the target network node to discard one or more PDUs from the set of scheduled PDUs in accordance with the timing information. In some aspects, the target network node may use the timing information to predict which PDUs of the set of scheduled PDUs may be expired or are likely to expire before reception by the UE. Therefore, the target network node may discard a first subset of PDUs of the set of PDUs that have expired or are predicted to expire. In some aspects, the target network node may forward the timing information to the source network node for the source network node to determine the first subset of PDUs that are predicted to expire. Therefore, the source network node may discard the first subset of PDUs and forward to the target network node only a second subset of PDUs predicted to be unexpired upon reception by the UE. In some aspects, the target network node may transmit, to the UE, the second subset of PDUs predicted to arrive at the UE before expiration. In some aspects, the UE may transmit capability information indicating support to reduce discarded PDUs after handover. In some aspects, the UE may be enabled by the source network node to transmit the timing information based on the capability information.

Particular aspects of the subject matter described in this disclosure can be implemented to realize one or more of the following potential advantages. In some examples, the described techniques can be used to reduce the number of PDUs that are discarded by the UE after a handover. For example, based on the UE indicating the timing information, the source network node and/or the target network node may identify and discard the first subset of PDUs that are predicted to expire or predicted to otherwise not satisfy the state of the timer associated with the PDU stored in the delay buffer at the UE. Therefore, the target network node may reduce the number of expired PDUs transmitted to the UE, which may reduce signaling overhead. Additionally, the reduced number of discarded PDUs may reduce energy expenditure associated with the UE receiving, storing, and/or processing expired PDUs. Additionally, by receiving PDUs before the applicable timer has expired, the UE may reduce the number of PDUs that are discarded, which may further reduce energy expenditure at the UE. Additionally, in examples where the target network node requests for the source network node to not forward the first subset of PDUs that are predicted to expire before reception at the UE, the source network node may reduce network overhead associated with the handover to the target network node. Such reductions in overhead associated with handover may further reduce latency associated with completing the handover, which may reduce a time associated with the data service interruption at the UE.

As described above, wireless communication systems may be deployed to provide various services, which may involve carrying or supporting voice, text, other messaging, video, data, and/or other traffic. Some wireless communications systems may employ multiple-access radio access technologies (RATs). The multiple-access RATs may be capable of supporting communication with multiple wireless communication devices by sharing the available system resources (for example, time domain resources, frequency domain resources, spatial domain resources, and/or device transmit power, among other examples). Examples of such multiple-access RATs include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

Multiple-access RATs are supported by technological advancements that have been adopted in various telecommunication standards, which define common protocols that enable wireless communication devices to communicate on a local, municipal, enterprise, national, regional, or global level. For example, 5G New Radio (NR) is part of a continuous mobile broadband evolution promulgated by the Third Generation Partnership Project (3GPP). 5G NR may support enhanced mobile broadband (eL3) access, Internet of Things (IoT) networks or reduced capability (RedCap) device deployments, ultra-reliable low-latency communication (URLLC) applications, and/or massive machine-type communication (mMTC), among other examples.

To support these and other target verticals, a wireless communication system may be designed to implement a modularized functional infrastructure, a disaggregated and service-based network architecture, network function virtualization, network slicing, multi-access edge computing, millimeter wave (mmWave) technologies including massive multiple-input multiple-output (MIMO), beamforming, IoT device or RedCap device connectivity and management, industrial connectivity, licensed and unlicensed spectrum access, sidelink and other device-to-device direct communication (for example, cellular vehicle-to-everything (CV2X) communication), frequency spectrum expansion, overlapping spectrum use, small cell deployments, non-terrestrial network (NTN) deployments, device aggregation, advanced duplex communication (for example, sub-band full-duplex (SBFD)), multiple-subscriber implementations, high-precision positioning, radio frequency (RF) sensing, network energy savings (NES), low-power signaling and radios, and/or artificial intelligence or machine learning (AI/ML), among other examples.

The foregoing and other technological improvements may support use cases, such as wireless fronthauls, wireless midhauls, wireless backhauls, wireless data centers, extended reality (XR) and metaverse applications, meta services for supporting vehicle connectivity, holographic and mixed reality communication, autonomous and collaborative robots, vehicle platooning and cooperative maneuvering, sensing networks, gesture monitoring, human-brain interfacing, digital twin applications, asset management, and universal coverage applications using non-terrestrial and/or aerial platforms, among other examples.

As the demand for connectivity continues to increase, further improvements in NR may be implemented, and other RATs, such as 6G and beyond, may be introduced to enable new applications and facilitate new use cases. The methods, operations, apparatuses, and techniques described herein may enable one or more of the foregoing technologies or new technologies and/or support one or more of the foregoing use cases or new use cases.

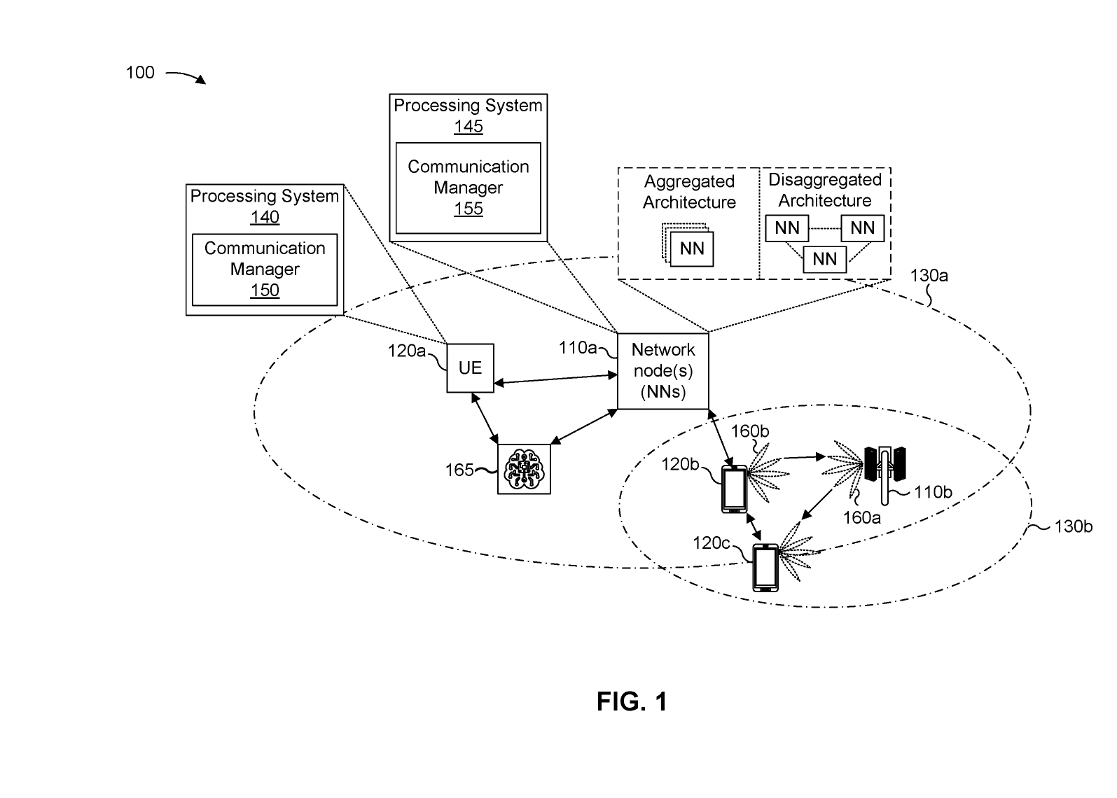

FIG. 1 is a diagram illustrating an example of a wireless communication network 100, in accordance with the present disclosure. The wireless communication network 100 may be or may include elements of a 5G (or NR) network or a 6G network, among other examples. The wireless communication network 100 may include multiple network nodes 110. For example, in FIG. 1, the wireless communication network 100 includes a network node (NN) 110a and a network node 110b. The network nodes 110 may support communications with multiple UEs 120. For example, in FIG. 1, the network nodes 110 support communication with a UE 120a, a UE 120b, and a UE 120c. In some examples, a UE 120 may also communicate with other UEs 120 and a network node 110 may communicate with a core network and with other network nodes 110.

The network nodes 110 and the UEs 120 of the wireless communication network 100 may communicate using the electromagnetic spectrum, which may be subdivided by frequency or wavelength into various classes, bands, carriers, and/or channels. For example, devices of the wireless communication network 100 may communicate using one or more operating bands. In some aspects, multiple wireless communication networks 100 may be deployed in a given geographic area. Each wireless communication network 100 may support a particular RAT (which may also be referred to as an air interface) and may operate on one or more carrier frequencies in one or more frequency bands or ranges. In some examples, when multiple RATs are deployed in a given geographic area, each RAT in the geographic area may operate on different frequencies to avoid interference with other RATs. Additionally or alternatively, in some examples, the wireless communication network 100 may implement dynamic spectrum sharing (DSS), in which multiple RATs are implemented with dynamic bandwidth allocation (for example, based on user demand) in a single frequency band. In some examples, the wireless communication network 100 may support communication over unlicensed spectrum, where access to an unlicensed channel is subject to a channel access mechanism. For example, in a shared or unlicensed frequency band, a transmitting device may perform a channel access procedure, such as a listen-before-talk (LBT) procedure, to contend against other devices for channel access before transmitting on a shared or unlicensed channel.

Various operating bands have been defined as frequency range designations FR1 (410 MHz through 7.125 GHz), FR2 (24.25 GHz through 52.6 GHz), FR3 (7.125 GHz through 24.25 GHz), FR4a or FR4-1 (52.6 GHz through 71 GHz), FR4 (52.6 GHz through 114.25 GHz), and FR5 (114.25 GHz through 300 GHz). Although a portion of FR1 is greater than 6 GHz, FR1 is often referred to (interchangeably) as a “sub-6 GHz” band in some documents and articles. Similarly, FR2 is often referred to (interchangeably) as a “millimeter wave” band in some documents and articles, despite being different than the extremely high frequency (EHF) band (30 GHz through 300 GHz), which is identified by the International Telecommunications Union (ITU) as a “millimeter wave” band. The frequencies between FR1 and FR2 are often referred to as mid-band frequencies, which include FR3. Frequency bands falling within FR3 may inherit FR1 characteristics or FR2 characteristics, and thus may effectively extend features of FR1 or FR2 into the mid-band frequencies. Thus, “sub-6 GHz,” if used herein, may broadly refer to frequencies that are less than 6 GHz, that are within FR1, and/or that are included in mid-band frequencies. Similarly, the term “millimeter wave,” if used herein, may broadly refer to mid-band frequencies or to frequencies that are within FR2, FR4, FR4-a or FR4-1, FR5, and/or the EHF band. Higher frequency bands may extend 5G NR operation, 6G operation, and/or other RATs beyond 52.6 GHz.

A network node 110 and/or a UE 120 may include one or more devices, components, or systems that enable communication with other devices, components, or systems of the wireless communication network 100. For example, a UE 120 and a network node 110 may each include one or more chips, system-on-chips (SoCs), chipsets, packages, or devices that individually or collectively constitute or comprise a processing system, such as a processing system 140 of the UE 120 or a processing system 145 of the network node 110. A processing system (for example, the processing system 140 and/or the processing system 145) includes processor (or “processing”) circuitry in the form of one or multiple processors, microprocessors, processing units (such as central processing units (CPUs), graphics processing units (GPUs), neural processing units (NPUs) (also referred to as neural network processors or deep learning processors (DLPs)), and/or digital signal processors (DSPs)), processing blocks, application-specific integrated circuits (ASICs), programmable logic devices (PLDs), or other discrete gate or transistor logic or circuitry (any one or more of which may be generally referred to herein individually as a “processor” or collectively as “the processor” or “the processor circuitry”). Such processors may be individually or collectively configurable or configured to perform various functions or operations described herein. A group of processors collectively configurable or configured to perform a set of functions may include a first processor configurable or configured to perform a first function of the set and a second processor configurable or configured to perform a second function of the set. In some other examples, each of a group of processors may be configurable or configured to perform a same set of functions.

The processing system 140 and the processing system 145 may each include memory circuitry in the form of one or multiple memory devices, memory blocks, memory elements, or other discrete gate or transistor logic or circuitry, each of which may include or implement tangible storage media such as random-access memory (RAM) or read-only memory (ROM), or combinations thereof (any one or more of which may be generally referred to herein individually as a “memory” or collectively as “the memory” or “the memory circuitry”). One or more of the memories may be coupled (for example, operatively coupled, communicatively coupled, electronically coupled, or electrically coupled) with one or more of the processors and may individually or collectively store processor-executable code or instructions (such as software) that, when executed by one or more of the processors, may configure one or more of the processors to perform various functions or operations described herein. Additionally or alternatively, in some examples, one or more of the processors may be configured to perform various functions or operations described herein without requiring configuration by software. “Software” shall be construed broadly to mean instructions, instruction sets, code, code segments, program code, programs, subprograms, software modules, applications, software applications, software packages, routines, subroutines, objects, executables, threads of execution, procedures, or functions, among other examples, whether referred to as software, firmware, middleware, microcode, hardware description language, or otherwise.

The processing system 140 and the processing system 145 may each include or be coupled with one or more modems (such as a cellular (for example, a 5G or 6G compliant) modem). In some examples, one or more processors of the processing system 140 and/or the processing system 145 include or implement one or more of the modems. The processing system 140 and the processing system 145 may also include or be coupled with multiple radios (collectively “the radio”), multiple RF chains, or multiple transceivers, each of which may in turn be coupled with one or more of multiple antennas. In some examples, one or more processors of the processing system 140 and/or the processing system 145 include or implement one or more of the radios, RF chains, or transceivers. An RF chain may include one or more filters, mixers, oscillators, amplifiers, analog-to-digital converters (ADCs), and/or other devices that convert between an analog signal (such as for transmission or reception via an air interface) and a digital signal (such as for processing by the processing system 140 of the UE 120 or by the processing system 145 of the network node 110).

A network node 110 and a UE 120 may each include one or multiple antennas or antenna arrays. Typical network nodes 110 and UEs 120 may include multiple antennas, which may be organized or structured into one or more antenna panels, one or more antenna groups, one or more sets of antenna elements, or one or more antenna arrays, among other examples. As used herein, the term “antenna” can refer to one or more antennas, one or more antenna panels, one or more antenna groups, one or more sets of antenna elements, or one or more antenna arrays. The term “antenna panel” can refer to a group of antennas (such as antenna elements) arranged in an array or panel, which may facilitate beamforming by manipulating parameters associated with the group of antennas. The term “antenna module” may refer to circuitry including one or more antennas as well as one or more other components (such as filters, amplifiers, or processors) associated with integrating the antenna module into a wireless communication device such as the network node 110 and the UE 120.

A network node 110 may be, may include, or may also be referred to as an NR network node, a 5G network node, a 6G network node, a Node B, a gNB, an access point (AP), a transmission reception point (TRP), a network entity, a network element, a network equipment, and/or another type of device, component, or system included in a radio access network (RAN). In various deployments, a network node 110 may be implemented as a single physical node (for example, a single physical structure) or may be implemented as two or more physical nodes (for example, two or more distinct physical structures). For example, a network node 110 may be a device or system that implements a part of a radio protocol stack, a device or system that implements a full radio protocol stack (such as a full gNB protocol stack), or a collection of devices or systems that collectively implement the full radio protocol stack. For example, and as shown, a network node 110 may be an aggregated network node having an aggregated architecture, meaning that the network node 110 may implement a full radio protocol stack that is physically and logically integrated within a single physical structure in the wireless communication network 100. For example, an aggregated network node 110 may consist of a single standalone base station or a single TRP that operates with a full radio protocol stack to enable or facilitate communication between a UE 120 and a core network of the wireless communication network 100.

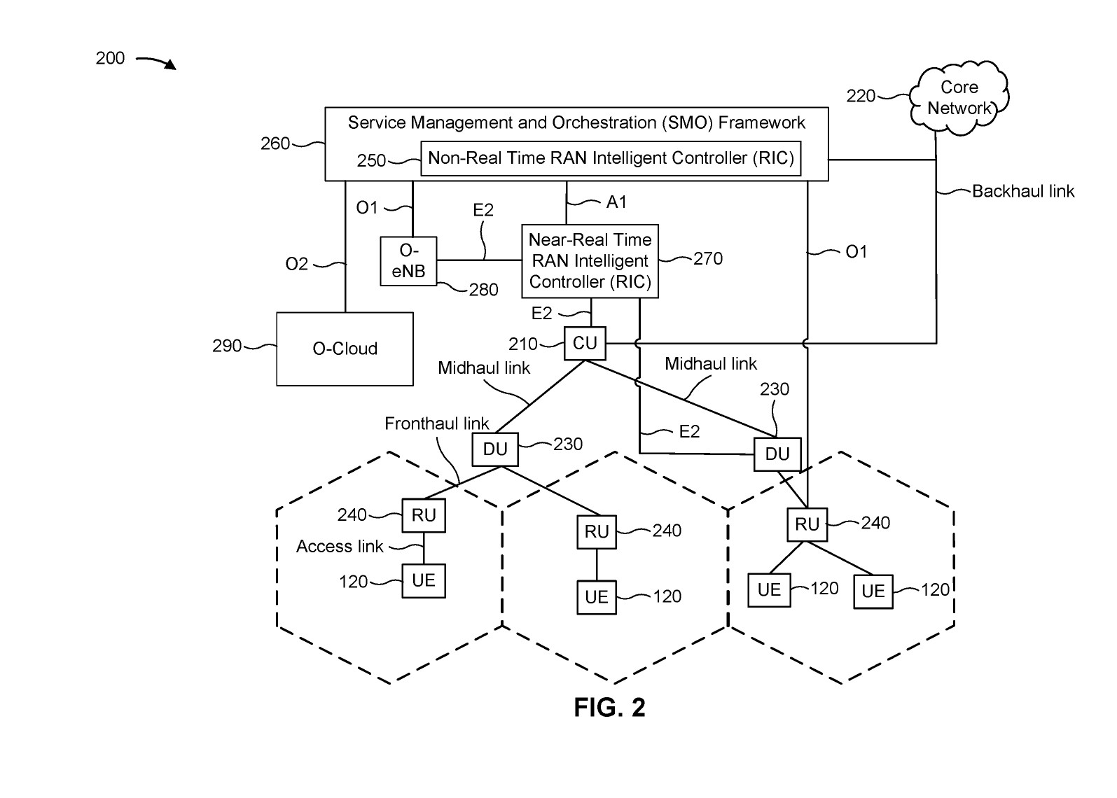

Alternatively, and as also shown, a network node 110 may be a disaggregated network node (sometimes referred to as a disaggregated base station), having a disaggregated architecture, meaning that the network node 110 may operate with a radio protocol stack that is physically distributed and/or logically distributed among two or more nodes in the same geographic location or in different geographic locations. An example disaggregated network node architecture is described in more detail below with reference to FIG. 2. In some deployments, disaggregated network nodes 110 may be used in an integrated access and backhaul (IAB) network, in an open radio access network (O-RAN) (such as a network configuration in compliance with the O-RAN Alliance), or in a virtualized radio access network (vRAN), also known as a cloud radio access network (C-RAN), to facilitate scaling by separating network functionality into multiple units or modules that can be individually deployed.

The network nodes 110 of the wireless communication network 100 may include one or more central units (CUs), one or more distributed units (DUs), and one or more radio units (RUs). A CU may host one or more higher layers, such as a radio resource control (RRC) layer, a PDCP layer, and a service data adaptation protocol (SDAP) layer, among other examples. A DU may host one or more of a radio link control (RLC) layer, a medium access control (MAC) layer, and/or one or more higher physical (PHY) layers depending, at least in part, on a functional split, such as a functional split defined by the 3GPP. In some examples, a DU also may host a lower PHY layer that is configured to perform functions, such as a fast Fourier transform (FFT), an inverse FFT (IFFT), beamforming, and/or physical random access channel (PRACH) extraction and filtering, among other examples. An RU may perform RF processing functions or lower PHY layer functions, such as an FFT, an IFFT, beamforming, or PRACH extraction and filtering, among other examples, according to a functional split, such as a lower layer split (LLS). In such an architecture, each RU can be operated to handle over the air (OTA) communication with one or more UEs 120. In some examples, a single network node 110 may include a combination of one or more CUs, one or more DUs, and/or one or more RUs. In some examples, a CU, a DU, and/or an RU may be implemented as a virtual unit, such as a virtual central unit (VCU), a virtual distributed unit (VDU), or a virtual radio unit (VRU), among other examples, which may be implemented as a virtual network function, such as in a cloud deployment.

Some network nodes 110 (for example, a base station, an RU, or a TRP) may provide communication coverage for a particular geographic area. The term “cell” can refer to a coverage area of a network node 110 or to a network node 110 itself, depending on the context in which the term is used. A network node 110 may support one or more cells (for example, each cell may support communication within an angular (for example, 60 degree) range around the network node). In some examples, a network node 110 may provide communication coverage for a macro cell, a pico cell, a femto cell, or another type of cell. A macro cell may cover a relatively large geographic area (for example, several kilometers in radius) and may allow unrestricted access by UEs 120 with associated service subscriptions. A pico cell may cover a relatively small geographic area and may also allow unrestricted access by UEs 120 with associated service subscriptions. A femto cell may cover a relatively small geographic area (for example, a home) and may allow restricted access by UEs 120 having association with the femto cell (for example, UEs 120 in a closed subscriber group (CSG)). In some examples, a cell may not necessarily be stationary. For example, the geographic area of the cell may move according to the location of an associated mobile network node 110 (for example, a train, a satellite, an unmanned aerial vehicle, or an NTN network node).

The wireless communication network 100 may be a heterogeneous network that includes network nodes 110 of different types, such as macro network nodes, pico network nodes, femto network nodes, relay network nodes, aggregated network nodes, and/or disaggregated network nodes, among other examples. Various different types of network nodes 110 may generally transmit at different power levels, serve different coverage areas (for example, a cell 130a and a cell 130b), and/or have different impacts on interference in the wireless communication network 100 than other types of network nodes 110.

The UEs 120 may be physically dispersed throughout the coverage area of the wireless communication network 100, and each UE 120 may be stationary or mobile. A UE 120 may be, may include, or may also be referred to as an access terminal, a mobile station, or a subscriber unit. A UE 120 may be, include, or be coupled with a cellular phone (for example, a smart phone), a personal digital assistant (PDA), a wireless modem, a wireless communication device, a handheld device, a laptop computer, a cordless phone, a wireless local loop (WLL) station, a tablet, a camera, a netbook, a smartbook, an ultrabook, a medical device, a biometric device, a wearable device (for example, a smart watch, smart clothing, smart glasses, a smart wristband, or smart jewelry), a gaming device, an entertainment device (for example, a music device, a video device, or a satellite radio), an XR device, a vehicular component or sensor, a smart meter or sensor, industrial manufacturing equipment, a Global Navigation Satellite System (GNSS) device (such as a Global Positioning System device or another type of positioning device), a UE function of a network node, and/or any other suitable device or function that may communicate via a wireless medium.

Some UEs 120 may be classified according to different categories in association with different complexities and/or different capabilities. UEs 120 in a first category may facilitate massive IoT in the wireless communication network 100, and may offer low complexity and/or cost relative to UEs 120 in a second category. UEs 120 in a second category may include mission-critical IoT devices, legacy UEs, baseline UEs, high-tier UEs, advanced UEs, full-capability UEs, and/or premium UEs that are capable of URLLC, eL3, and/or precise positioning in the wireless communication network 100, among other examples. A third category of UEs 120 may have mid-tier complexity and/or capability (for example, a capability between that of the UEs 120 of the first category and that of the UEs 120 of the second capability). A UE 120 of the third category may be referred to as a reduced capability UE (“RedCap UE”), a mid-tier UE, an NR-Light UE, and/or an NR-Lite UE, among other examples. RedCap UEs may bridge a gap between the capability and complexity of NB-IoT devices and/or eMTC UEs, and mission-critical IoT devices and/or premium UEs. RedCap UEs may include, for example, wearable devices, IoT devices, industrial sensors, or cameras that are associated with a limited bandwidth, power capacity, and/or transmission range, among other examples. RedCap UEs may support healthcare environments, building automation, electrical distribution, process automation, transport and logistics, or smart city deployments, among other examples.

In some examples, a network node 110 may be, may include, or may operate as an RU, a TRP, or a base station that communicates with one or more UEs 120 via a radio access link (which may be referred to as a “Uu” link). The radio access link may include a downlink and an uplink. “Downlink” (or “DL”) refers to a communication direction from a network node 110 to a UE 120, and “uplink” (or “UL”) refers to a communication direction from a UE 120 to a network node 110. Downlink and uplink resources may include time domain resources (for example, frames, subframes, slots, and symbols), frequency domain resources (for example, frequency bands, component carriers (CCs), subcarriers, resource blocks, and resource elements), and spatial domain resources (for example, particular transmit directions or beams).

Frequency domain resources may be subdivided into bandwidth parts (BWPs). A BWP may be a block of frequency domain resources (for example, a continuous set of resource blocks (RBs) within a full component carrier bandwidth) that may be configured at a UE-specific level. A UE 120 may be configured with both an uplink BWP and a downlink BWP (which may be the same or different). Each BWP may be associated with its own numerology (indicating a sub-carrier spacing (SCS) and cyclic prefix (CP)). A BWP may be dynamically configured or activated (for example, by a network node 110 transmitting a downlink control information (DCI) configuration to the one or more UEs 120) and/or reconfigured (for example, in real-time or near-real-time) according to changing network conditions in the wireless communication network 100 and/or specific requirements of one or more UEs 120. An active BWP defines the operating bandwidth of the UE 120 within the operating bandwidth of the serving cell. The use of BWPs enables more efficient use of the available frequency domain resources in the wireless communication network 100 because fewer frequency domain resources may be allocated to a BWP for a UE 120 (which may reduce the quantity of frequency domain resources that a UE 120 is required to monitor and reduce UE power consumption by enabling the UE to monitor fewer frequency domain resources), leaving more frequency domain resources to be spread across multiple UEs 120. Thus, BWPs may also assist in the implementation of lower-capability (for example, RedCap) UEs 120 by facilitating the configuration of smaller bandwidths for communication by such UEs 120 and/or by facilitating reduced UE power consumption.

As used herein, a downlink signal may be or include a reference signal, control information, or data. For example, downlink reference signals include a primary synchronization signal (PSS), a secondary SS (SSS), an SS block (SSB) (for example, that includes a PSS, an SSS, and a physical broadcast channel (PBCH)), a demodulation reference signal (DMRS), a phase tracking reference signal (PTRS), a tracking reference signal (TRS), and a channel state information (CSI) reference signal (CSI-RS), among other examples. A downlink signal carrying control information or data may be transmitted via a downlink channel. Downlink channels may include one or more control channels for transmitting control information and one or more data channels for transmitting data. Downlink reference signals may be transmitted in addition to, or multiplexed with, downlink control channel communications and/or downlink data channel communications. A downlink control channel may be specifically used to transmit DCI from a network node 110 to a UE 120. DCI generally contains the information the UE 120 needs to identify RBs in a subsequent subframe and how to decode them, including a modulation and coding scheme (MCS) or redundancy version parameters. Different DCI formats carry different information, such as scheduling information in the form of downlink or uplink grants, slot format indicators (SFIs), preemption indicators (PIs), transmit power control (TPC) commands, hybrid automatic repeat request (HARQ) information, new data indicators (NDIs), among other examples. A downlink data channel may be used to transmit downlink data (for example, user data associated with a UE 120) from a network node 110 to a UE 120. Downlink control channels may include physical downlink control channels (PDCCHs), and downlink data channels may include physical downlink shared channels (PDSCHs). Control information or data communications may be transmitted on a PDCCH and PDSCH, respectively. For example, a PDCCH can carry DCI, while a PDSCH can carry a MAC control element (MAC-CE), an RRC message, or user data, among other examples. Each PDSCH may carry one or more transport blocks (TBs) of data.

As used herein, an uplink signal may include a reference signal, control information, or data. For example, uplink reference signals include a sounding reference signal (SRS), a PTRS, and a DMRS, among other examples. An uplink signal carrying control information or data may be transmitted via an uplink channel. An uplink channel may include one or more control channels for transmitting control information and one or more data channels for transmitting data. Uplink reference signals may be transmitted in addition to, or multiplexed with, uplink control channel communications and/or uplink data channel communications. An uplink control channel may be specifically used to transmit uplink control information (UCI) from a UE 120 to a network node 110. An uplink data channel may be used to transmit uplink data (for example, user data associated with a UE 120) from a UE 120 to a network node 110. Uplink control channels may include physical uplink control channels (PUCCHs), and uplink data channels may include physical uplink shared channels (PUSCHs). Control information or data communications may be transmitted on a PUCCH and PUSCH, respectively. For example, a PUCCH can carry UCI, while a PUSCH can carry a MAC-CE, an RRC message, or user data, among other examples. UCI can include a scheduling request (SR), HARQ feedback information (for example, a HARQ acknowledgement (ACK) indication or a HARQ negative acknowledgement (NACK) indication), uplink power control information (for example, an uplink TPC parameter), and/or CSI, among other examples. CSI can include a channel quality indicator (CQI) (indicative of downlink channel conditions to facilitate selection of transmission parameters, such as an MCS, by a network node 110), a precoding matrix indicator (PMI), a CSI-RS resource indicator (CRI) (for example, indicative of a beam used to transmit a CSI-RS), an SS/PBCH resource block indicator (SSBRI) (for example, indicative of a beam used to transmit an SSB), a layer indicator (LI), a rank indicator (RI), and/or measurement information (for example, a layer 1 (L1)- reference signal received power (RSRP) parameter, a received signal strength indicator (RSSI) parameter, a reference signal received quality (RSRQ) parameter, among other examples) which can be used for beam management, among other examples. Each PUSCH may carry one or more TBs of data.

The information (for example, data, control information, or reference signal information) transmitted by a network node 110 to a UE 120, or vice versa, may be represented as a sequence of binary bits that are mapped (for example, modulated) to an analog signal waveform (for example, a discrete Fourier transform (DFT)-spread-orthogonal frequency division multiplexing (OFDM) (DFT-s-OFDM) waveform or a CP-OFDM waveform) that is transmitted by the network node 110 or UE 120 over a wireless communication channel. In some examples, the network node 110 or the UE 120 (for example, using the processing system 145 or the processing system 140, respectively) may select an MCS (for example, an order of quadrature amplitude modulation (QAM), such as 64-QAM, 128-QAM, or 256-QAM, among other examples) for a downlink signal or an uplink signal. For example, the network node 110 may select an MCS for a downlink signal in accordance with UCI received from the UE 120. The network node 110 may transmit, to the UE 120, an indication of the selected MCS for the downlink signal, such as via DCI that schedules the downlink signal. As another example, the network node 110 may transmit, and the UE 120 may receive, an indication of an MCS to be applied for the one or more uplink signals, such as via DCI scheduling transmission of the one or more uplink signals.

The network node 110 or the UE 120 (such as by using the processing system 145 or the processing system 140, respectively, and/or one or more coupled modems) may perform signal processing on the information (such as filtering, amplification, modulation, digital-to-analog conversion, an IFFT operation, multiplexing, interleaving, mapping, and/or encoding, among other examples) to generate a processed signal in accordance with the selected MCS. In some examples, the network node 110 or the UE 120 (for example, using the processing system 145 or the processing system 140, respectively, and/or one or more coupled encoders or modems) may perform a channel coding operation or a forward error correction (FEC) operation to control errors in transmitted information. For example, the network node 110 or the UE 120 may perform an encoding operation to generate encoded information (such as by selectively introducing redundancy into the information, typically using an error correction code (ECC), such as a polar code or a low-density parity-check (LDPC) code). The network node 110 or the UE 120 (for example, using the processing system 145 and/or one or more modems) may further perform spatial processing (for example, precoding) on the encoded information to generate one or more processed or precoded signals for downlink or uplink transmission, respectively. In some examples, the network node 110 or the UE 120 may perform codebook-based precoding or non-codebook-based precoding. Codebook-based precoding may involve selecting a precoder (for example, a precoding matrix) using a codebook. For example, the network node 110 may provide precoding information indicating which precoder, defined by the codebook, is to be used by the UE 120. Non-codebook-based precoding may involve selecting or deriving a precoder based on, or otherwise associated with, one or more downlink or uplink signal measurements. The network node 110 or the UE 120 may transmit the processed downlink or uplink signals, respectively, via one or more antennas.

The network node 110 or the UE 120 may receive uplink signals or downlink signals, respectively, via one or more antennas. The network node 110 or the UE 120 (for example, using the processing system 145 or the processing system 140, respectively, and/or one or more coupled modems) may perform signal processing (for example, in accordance with the MCS) on the received uplink or downlink signals, respectively (such as filtering, amplification, demodulation, analog-to-digital conversion, an FFT operation, demultiplexing, deinterleaving, de-mapping, equalization, interference cancellation, and/or decoding, among other examples), to map the received signal(s) to a sequence of binary bits (for example, received information) that estimates the information transmitted by the network node 110 or the UE 120 via the downlink or uplink signals. The network node 110 or the UE 120 (for example, using the processing system 145 or the processing system 140, respectively, and/or a coupled decoder or one or more modems) may decode the received information (such as by using an ECC, a decoding operation, and/or an FEC operation) to detect errors and/or correct bit errors in the received information to generate decoded information. The decoded information may estimate the information transmitted via the downlink or uplink signals.

In some examples, a UE 120 and a network node 110 may perform MIMO communication. “MIMO” generally refers to transmitting or receiving multiple signals (such as multiple layers or multiple data streams) simultaneously over the same time and frequency resources. MIMO techniques generally exploit multipath propagation. A network node 110 and/or UE 120 may communicate using massive MIMO, multi-user MIMO, or single-user MIMO, which may involve rapid switching between beams or cells. For example, the amplitudes and/or phases of signals transmitted via antenna elements and/or sub-elements may be modulated and shifted relative to each other (such as by manipulating a phase shift, a phase offset, and/or an amplitude) to generate one or more beams, which is referred to as beamforming. For example, the network node 110b may generate one or more beams 160a, and the UE 120b may generate one or more beams 160b. The term “beam” may refer to a directional transmission of a wireless signal toward a receiving device or otherwise in a desired direction, a directional reception of a wireless signal from a transmitting device or otherwise in a desired direction, a direction associated with a directional transmission or directional reception, a set of directional resources associated with a signal transmission or signal reception (for example, an angle of arrival, a horizontal direction, and/or a vertical direction), a set of parameters that indicate one or more aspects of a directional signal, a direction associated with the signal, and/or a set of directional resources associated with the signal, among other examples.

MIMO may be implemented using various spatial processing or spatial multiplexing operations. In some examples, MIMO may include a massive MIMO technique which may be associated with an increased (for example, “massive”) quantity of antennas at the network node 110 and/or at the UE 120, such as in a network implementing mmWave technology. Massive MIMO may improve communication reliability by enabling a network node 110 and/or a UE 120 to communicate the same data across different propagation (or spatial) paths. In some examples, MIMO may support simultaneous transmission to multiple receivers, referred to as multi-user MIMO (MU-MIMO). Some RATs may employ MIMO techniques, such as multi-TRP (mTRP) operation (including redundant transmission or reception on multiple TRPs), reciprocity in the time domain or the frequency domain, single-frequency-network (SFN) transmission, or non-coherent joint transmission (NC-JT).

To support MIMO techniques, the network node 110 and the UE 120 may perform one or more beam management operations, such as an initial beam acquisition operation, one or more beam refinement operations, and/or a beam recovery operation. For example, an initial beam acquisition operation may involve the network node 110 transmitting signals (for example, SSBs, CSI-RSs, or other signals) via respective beams (for example, of the beams 160a of the network node 110) and the UE 120 receiving and measuring the signal(s) via respective beams of multiple beams (for example, from the beams 160b of the UE 120) to identify a best beam (or beam pair) for communication between the UE 120 and the network node 110. For example, the UE 120 may transmit an indication (for example, in a message associated with a random access channel (RACH) operation) of a (best) identified beam of the network node 110 (for example, by indicating an SSBRI or other identifier associated with the beam). A beam refinement operation may involve a first device (for example, the UE 120 or the network node 110) transmitting signal(s) via a subset of beams (for example, identified based on, or otherwise associated with, measurements reported as part of one or more other beam management operations). A second device (for example, the network node 110 or the UE 120) may receive the signal(s) via a single beam (for example, to identify the best beam for communication from the subset of beams). The beam(s) may be identified via one or more spatial parameters, such as a transmission configuration indicator (TCI) state and/or a quasi co-location (QCL) parameter, among other examples. The network node 110 and the UE 120 may increase reliability and/or achieve efficiencies in throughput, signal strength, and/or other signal properties for massive MIMO operations by performing the beam management operations.

Some aspects and techniques as described herein may be implemented, at least in part, using an artificial intelligence (AI) program (for example, referred to herein as an “AI/ML model”), such as a program that includes a machine learning (ML) model and/or an artificial neural network (ANN) model. The AI/ML model may be deployed at one or more devices 165 (for example, a network node 110 and/or UEs 120). For example, the one or more devices 165 may include a UE 120 (for example, the processing system 140), a network node 110 (for example, the processing system 145), one or more servers, and/or one or more components of a cloud computing network, among other examples. In some examples, the AI/ML model (or an instance of the AI/ML model) may be deployed at multiple devices (for example, a first portion of the AI/ML model may be deployed at a UE 120 and a second portion of the AI/ML model may be deployed at a network node 110). In other examples, a first AI/ML model may be deployed at a UE 120 and a second AI/ML model may be deployed at a network node 110. The AI/ML model(s) may be configured to enhance various aspects of the wireless communication network 100. For example, the AI/ML model(s) may be trained to identify patterns or relationships in data corresponding to the wireless communication network 100, a device, and/or an air interface, among other examples. The AI/ML model(s) may support operational decisions relating to one or more aspects associated with wireless communications devices, networks, or services.

In some aspects, the UE 120 may include a communication manager 150. As described in more detail elsewhere herein, the communication manager 150 may receive, from a source network node, information associated with a handover from the source network node to a target network node; transmit, to the target network node after the handover from the source network node to the target network node, information associated with a PDU in a set of PDUs scheduled for transmission to the UE based at least in part on a timer associated with the PDU and a request for the target network node to discard a first subset PDUs of the set of PDUs based at least in part on the information associated with the PDU; and receive, from the target network node, a second subset of PDUs of the set of PDUs based at least in part on the information. Additionally, or alternatively, the communication manager 150 may perform one or more other operations described herein.

In some aspects, the network node 110 may include a communication manager 155. As described in more detail elsewhere herein, the communication manager 155 may receive, from a source network node, an indication of a set of PDUs scheduled for transmission to a UE; receive, from the UE after handover of the UE from the source network node to the target network node, information associated with a PDU in the set of PDUs scheduled for transmission to the UE based at least in part on a timer associated with the PDU and a request to discard a first subset PDUs of the set of PDUs based at least in part on the information; and transmit, to the UE, a second subset of PDUs of the set of PDUs based at least in part on the information. Additionally, or alternatively, the communication manager 155 may perform one or more other operations described herein.

FIG. 2 is a diagram illustrating an example disaggregated network node architecture 200, in accordance with the present disclosure. One or more components of the example disaggregated network node architecture 200 may be, may include, or may be included in one or more network nodes (such one or more network nodes 110). The disaggregated network node architecture 200 may include a CU 210 that can communicate directly with a core network 220 via a backhaul link, or that can communicate indirectly with the core network 220 via one or more disaggregated control units, such as a non-real-time (Non-RT) RAN intelligent controller (RIC) 250 associated with a Service Management and Orchestration (SMO) Framework 260 and/or a near-real-time (Near-RT) RIC 270 (for example, via an E2 link). The CU 210 may communicate with one or more DUs 230 via respective midhaul links, such as via F1 interfaces. Each of the DUs 230 may communicate with one or more RUs 240 via respective fronthaul links. Each of the RUs 240 may communicate with one or more UEs 120 via respective RF access links. In some deployments, a UE 120 may be simultaneously served by multiple RUs 240.

Each of the components of the disaggregated network node architecture 200, including the CUs 210, the DUs 230, the RUs 240, the Near-RT RICs 270, the Non-RT RICs 250, and the SMO Framework 260, may include one or more interfaces or may be coupled with one or more interfaces for receiving or transmitting signals, such as data or information, via a wired or wireless transmission medium.

In some aspects, the CU 210 may be logically split into one or more CU user plane (CU-UP) units and one or more CU control plane (CU-CP) units. A CU-UP unit may communicate bidirectionally with a CU-CP unit via an interface, such as the E1 interface when implemented in an O-RAN configuration. The CU 210 may be deployed to communicate with one or more DUs 230, as necessary, for network control and signaling. Each DU 230 may correspond to a logical unit that includes one or more base station functions to control the operation of one or more RUs 240. For example, a DU 230 may host various layers, such as an RLC layer, a MAC layer, or one or more PHY layers, such as one or more high PHY layers or one or more low PHY layers. Each layer (which also may be referred to as a module) may be implemented with an interface for communicating signals with other layers (and modules) hosted by the DU 230, or for communicating signals with the control functions hosted by the CU 210. Each RU 240 may implement lower layer functionality. In some aspects, real-time and non-real-time aspects of control and user plane communication with the RU(s) 240 may be controlled by the corresponding DU 230.

The SMO Framework 260 may support RAN deployment and provisioning of non-virtualized and virtualized network elements. For non-virtualized network elements, the SMO Framework 260 may support the deployment of dedicated physical resources for RAN coverage requirements, which may be managed via an operations and maintenance interface, such as an O1 interface. For virtualized network elements, the SMO Framework 260 may interact with a cloud computing platform (such as an open cloud (O-Cloud) platform 290) to perform network element life cycle management (such as to instantiate virtualized network elements) via a cloud computing platform interface, such as an O2 interface. A virtualized network element may include, but is not limited to, a CU 210, a DU 230, an RU 240, a non-RT RIC 250, and/or a Near-RT RIC 270. In some aspects, the SMO Framework 260 may communicate with a hardware aspect of a 4G RAN, a 5G NR RAN, and/or a 6G RAN, such as an open eNB (O-eNB) 280, via an O1 interface. Additionally or alternatively, the SMO Framework 260 may communicate directly with each of one or more RUs 240 via a respective O1 interface. In some deployments, this configuration can enable each DU 230 and the CU 210 to be implemented in a cloud-based RAN architecture, such as a vRAN architecture.

The Non-RT RIC 250 may include or may implement a logical function that enables non-real-time control and optimization of RAN elements and resources, AI/ML workflows including model training and updates, and/or policy-based guidance of applications and/or features in the Near-RT RIC 270. The Non-RT RIC 250 may be coupled to or may communicate with (such as via an A1 interface) the Near-RT RIC 270. The Near-RT RIC 270 may include or may implement a logical function that enables near-real-time control and optimization of RAN elements and resources via data collection and actions via an interface (such as via an E2 interface) connecting one or more CUs 210, one or more DUs 230, and/or an O-eNB 280 with the Near-RT RIC 270.

In some aspects, to generate AI/ML models to be deployed in the Near-RT RIC 270, the Non-RT RIC 250 may receive parameters or external enrichment information from external servers. Such information may be utilized by the Near-RT RIC 270 and may be received at the SMO Framework 260 or the Non-RT RIC 250 from non-network data sources or from network functions. In some examples, the Non-RT RIC 250 or the Near-RT RIC 270 may tune RAN behavior or performance. For example, the Non-RT RIC 250 may monitor long-term trends and patterns for performance and may employ AI/ML models to perform corrective actions via the SMO Framework 260 (such as reconfiguration via an O1 interface) or via creation of RAN management policies (such as A1 interface policies).

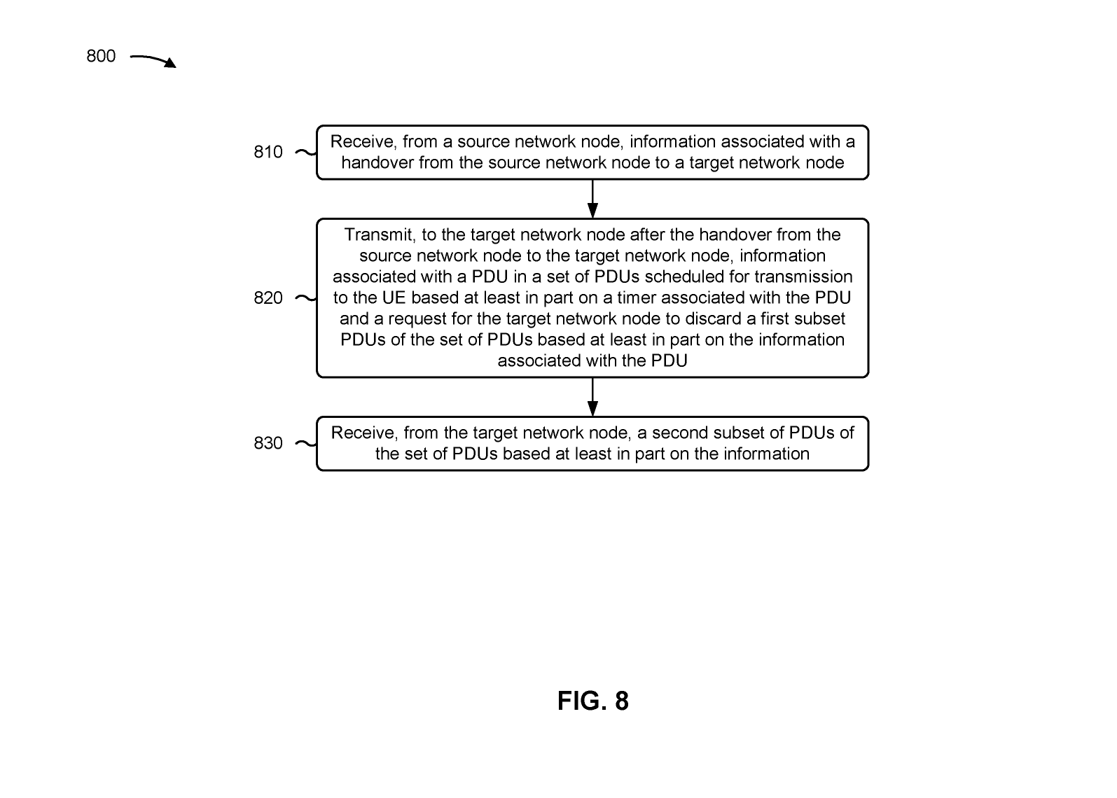

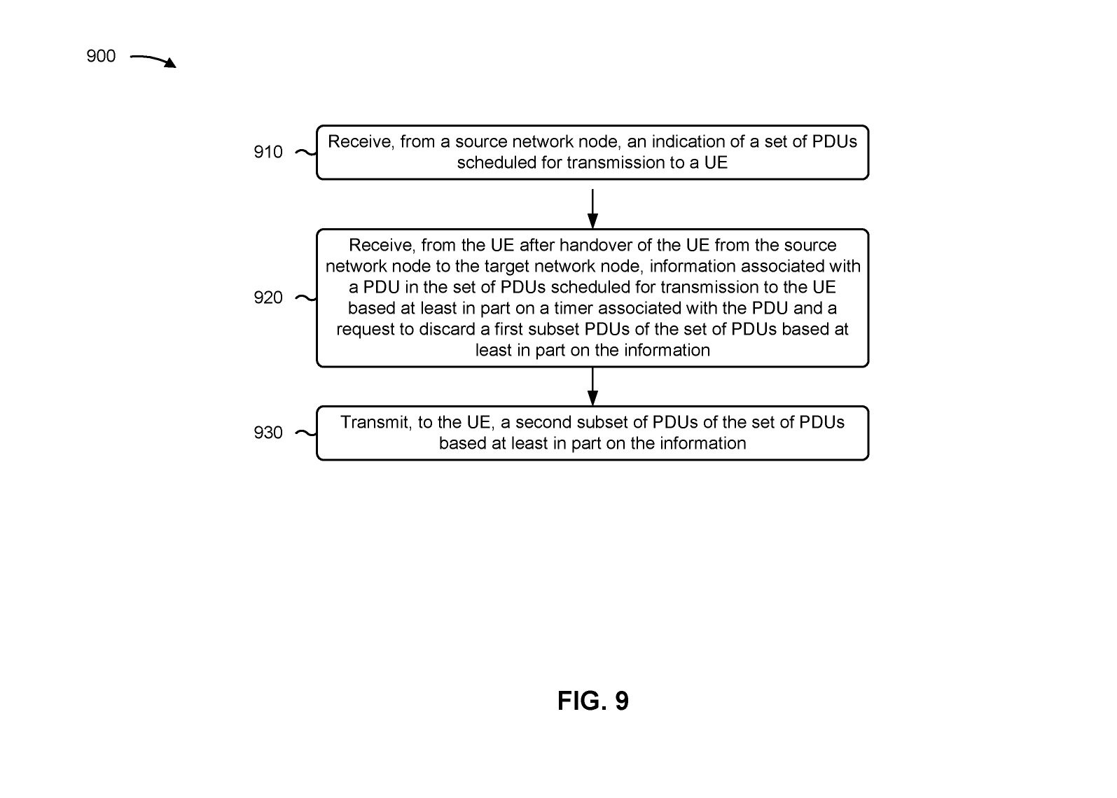

The network node 110, the processing system 145 of the network node 110, the UE 120, the processing system 140 of the UE 120, the CU 210, the DU 230, the RU 240, or any other component(s) of FIG. 1 and/or FIG. 2 may implement one or more techniques or perform one or more operations associated with PDU discard reduction after handover, as described in more detail elsewhere herein. For example, the processing system 145 of the network node 110, the processing system 140 of the UE 120, the CU 210, the DU 230, or the RU 240 may perform or direct operations of, for example, process 800 of FIG. 8, process 900 of FIG. 9 or other processes as described herein (alone or in conjunction with one or more other processors). Memory of the network node 110 may store data and program code (or instructions) for the network node 110, the CU 210, the DU 230, or the RU 240. In some examples, the memory of the network node 110 may store data relating to a UE 120, such as RRC state information or a UE context. Memory of a UE 120 may store data and program code (or instructions) for the UE 120, such as context information. In some examples, the memory of the UE 120 or the memory of the network node 110 may include a non-transitory computer-readable medium storing a set of instructions for wireless communication. For example, the set of instructions, when executed by one or more processors (for example, of the processing system 145 or the processing system 140) of the network node 110, the UE 120, the CU 210, the DU 230, or the RU 240, may cause the one or more processors to perform process 800 of FIG. 8, process 900 of FIG. 9, or other processes as described herein. In some examples, executing instructions may include running the instructions, converting the instructions, compiling the instructions, and/or interpreting the instructions, among other examples.

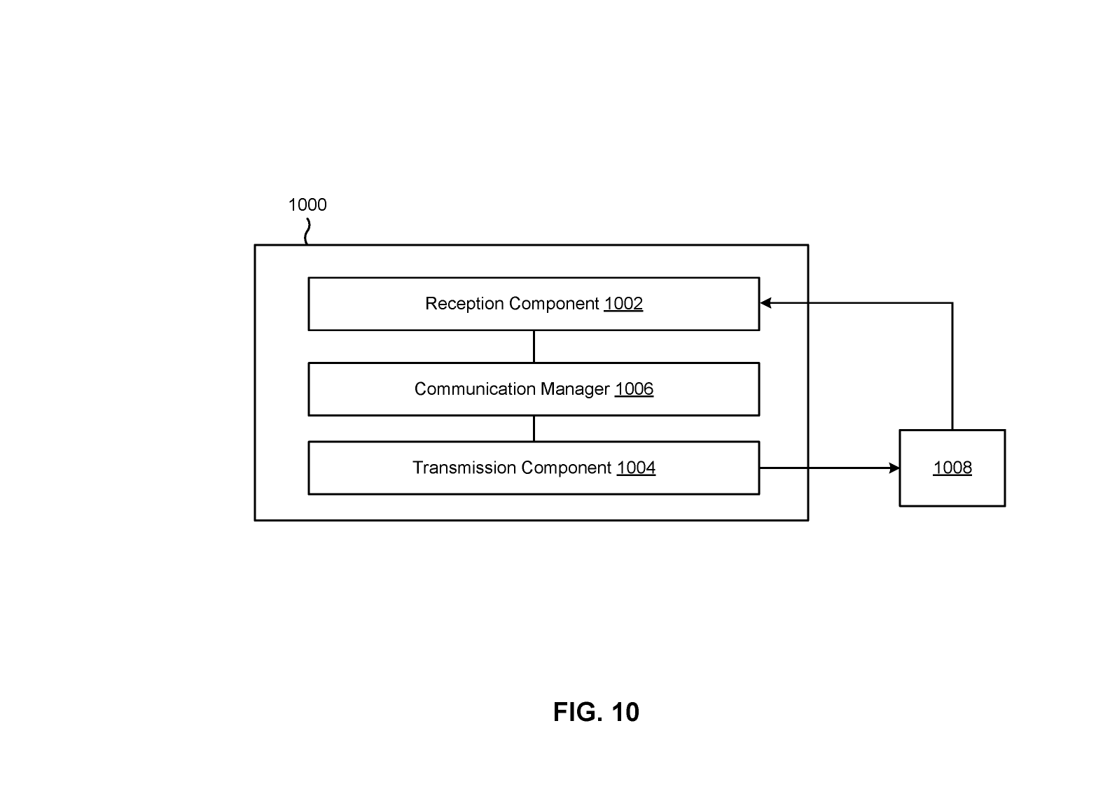

In some aspects, the UE includes means for receiving, from a source network node, information associated with a handover from the source network node to a target network node; means for transmitting, to the target network node after the handover from the source network node to the target network node, information associated with a PDU in a set of PDUs scheduled for transmission to the UE based at least in part on a timer associated with the PDU and a request for the target network node to discard a first subset PDUs of the set of PDUs based at least in part on the information associated with the PDU; and/or means for receiving, from the target network node, a second subset of PDUs of the set of PDUs based at least in part on the information. The means for the UE to perform operations described herein may include, for example, one or more of communication manager 150, processing system 140, a radio, one or more RF chains, one or more transceivers, one or more antennas, one or more modems, a reception component (for example, reception component 1002 depicted and described in connection with FIG. 10), and/or a transmission component (for example, transmission component 1004 depicted and described in connection with FIG. 10), among other examples.

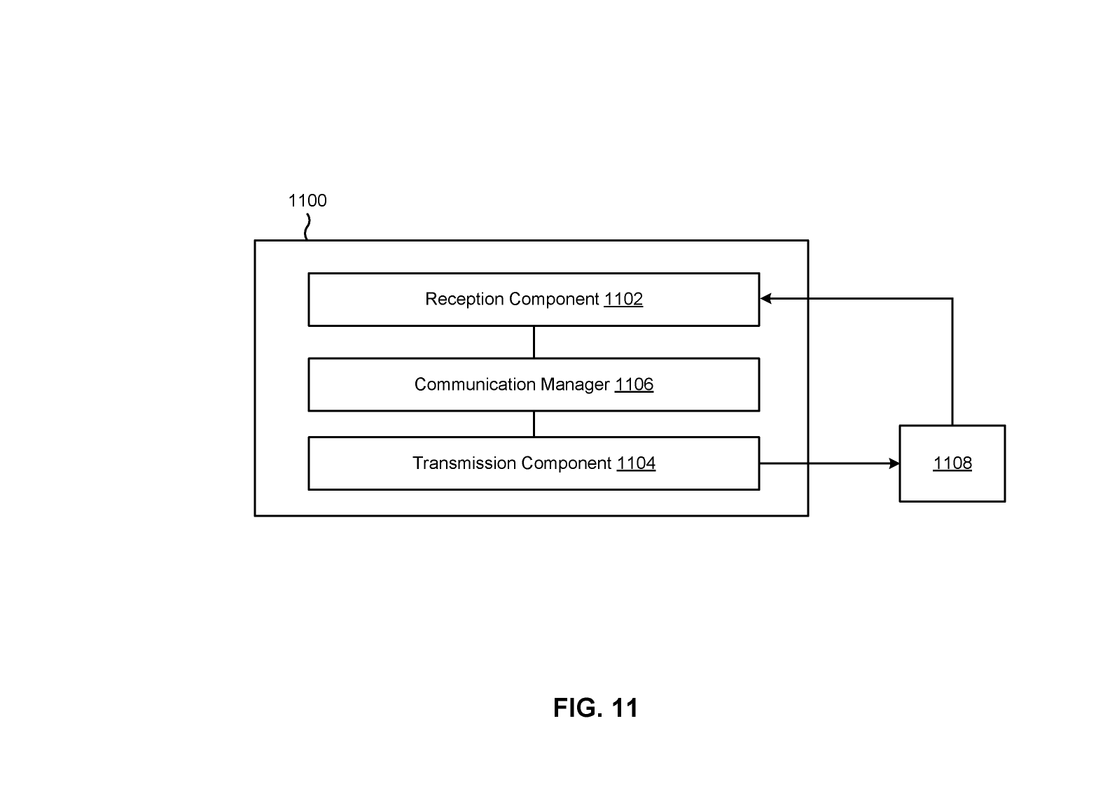

In some aspects, the target network node includes means for receiving, from a source network node, an indication of a set of PDUs scheduled for transmission to a UE; means for receiving, from the UE after handover of the UE from the source network node to the target network node, information associated with a PDU in the set of PDUs scheduled for transmission to the UE based at least in part on a timer associated with the PDU and a request to discard a first subset PDUs of the set of PDUs based at least in part on the information; and/or means for transmitting, to the UE, a second subset of PDUs of the set of PDUs based at least in part on the information. The means for the target network node to perform operations described herein may include, for example, one or more of communication manager 155, processing system 145, a radio, one or more RF chains, one or more transceivers, one or more antennas, one or more modems, a reception component (for example, reception component 1102 depicted and described in connection with FIG. 11), and/or a transmission component (for example, transmission component 1104 depicted and described in connection with FIG. 11), among other examples.

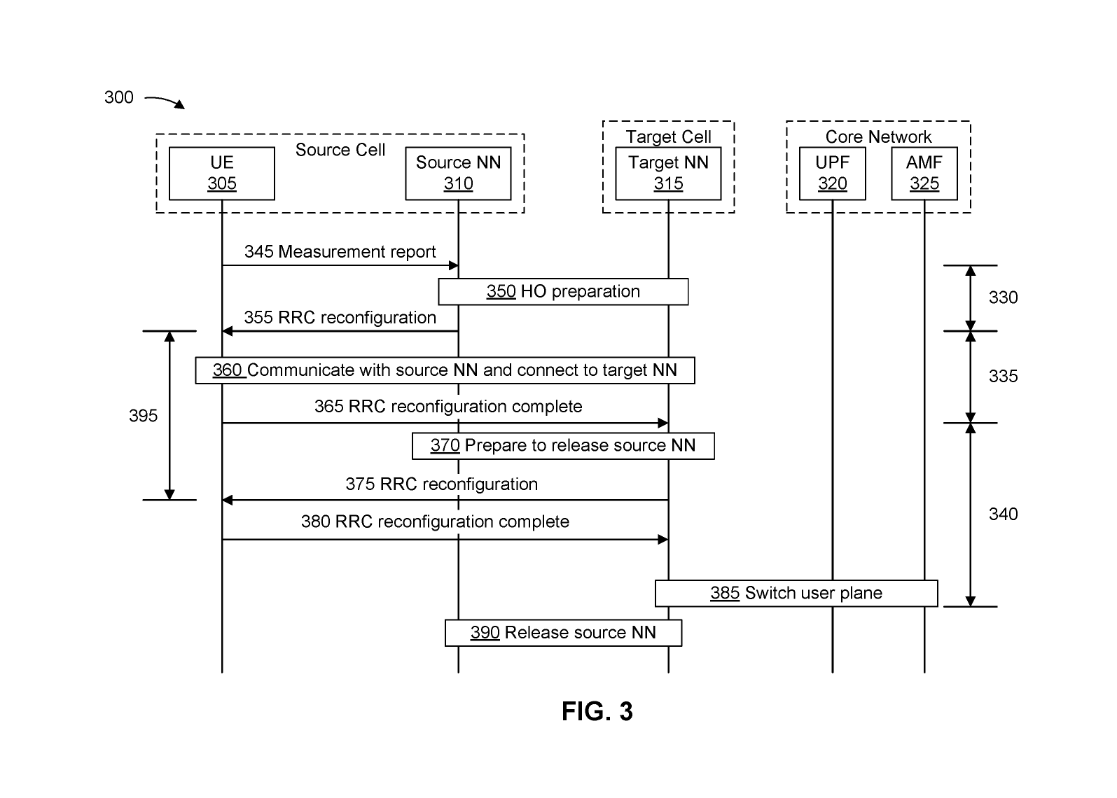

FIG. 3 is a diagram illustrating an example 300 of an L3 handover procedure, in accordance with the present disclosure.

As shown in FIG. 3, the L3 handover procedure may involve a UE 305, a source network node 310, a target network node 315, a user plane function (UPF) device 320, and an access and mobility management function (AMF) device 325. In some examples, actions described as being performed by a network node may be performed by multiple network nodes. For example, configuration actions and/or core network communication actions may be performed by a first network node (e.g., a CU or a DU), and radio communication actions may be performed by a second network node (e.g., a DU or an RU). The UE 305 may correspond to the UE 120 described elsewhere herein. The source network node 310 and/or the target network node 315 may correspond to the network node 110 described elsewhere herein. The UE 305 and the source network node 310 may be connected (e.g., may have an RRC connection) via a serving cell or a source cell, and the UE 305 may undergo a handover to the target network node 315 via a target cell. The UPF device 320 and/or the AMF device 325 may be located within a core network. The source network node 310 and the target network node 315 may be in communication with the core network for mobility support and user plane functions.

As shown in FIG. 3, the L3 handover procedure may include a handover preparation phase 330, a handover execution phase 335, and a handover completion phase 340. During the handover preparation phase 330, the UE 305 may report measurements that cause the source network node 310 and/or the target network node 315 to prepare for handover and trigger execution of the handover. During the handover execution phase 335, the UE 305 may execute the handover by performing a random access procedure with the target network node 315 and establishing an RRC connection with the target network node 315. During the handover completion phase 340, the source network node 310 may forward one or more stored communications associated with the UE 305 to the target network node 315, and the UE 305 may be released from a connection with the source network node 310.

As shown by reference number 345, during the handover preparation phase 330, the UE 305 may perform one or more measurements, and may transmit a measurement report to the source network node 310 based at least in part on the one or more measurements (e.g., serving cell measurements and/or neighbor cell measurements). The measurement report may indicate, for example, an RSRP parameter, an RSRQ parameter, an RSSI parameter, and/or a signal-to-interference-plus-noise-ratio (SINR) parameter (e.g., for the serving cell and/or one or more neighbor cells). The source network node 310 may use the measurement report to determine whether to trigger a handover to the target network node 315. For example, if one or more measurements satisfy a condition, the source network node 310 may trigger a handover of the UE 305 to the target network node 315.

As shown by reference number 350, during the handover preparation phase 330, the source network node 310 and the target network node 315 may communicate with one another to prepare for a handover of the UE 305. As part of the handover preparation, the source network node 310 may transmit a handover request to the target network node 315 to instruct the target network node 315 to prepare for the handover. The source network node 310 may communicate RRC context information associated with the UE 305 and/or configuration information associated with the UE 305 to the target network node 315. The target network node 315 may prepare for the handover by reserving resources for the UE 305. After reserving the resources, the target network node 315 may transmit an acknowledgement (ACK) to the source network node 310 in response to the handover request.

As shown by reference number 355, during the handover preparation phase 330, the source network node 310 may transmit an RRC reconfiguration message to the UE 305. The RRC reconfiguration message may include a handover command instructing the UE 305 to execute a handover procedure from the source network node 310 to the target network node 315. The handover command may include information associated with the target network node 315, such as a random access channel (RACH) preamble assignment for accessing the target network node 315. Reception of the RRC reconfiguration message, including the handover command, by the UE 305 may trigger the start of the handover execution phase 335.

As shown by reference number 360, during the handover execution phase 335, the UE 305 may execute the handover by performing a random access procedure with the target network node 315 (e.g., including synchronization with the target network node 315) while continuing to communicate with the source network node 310. For example, while the UE 305 is performing the random access procedure with the target network node 315, the UE 305 may transmit uplink data, uplink control information, and/or an uplink reference signal (e.g., an SRS) to the source network node 310, and/or may receive downlink data, DCI, and/or a downlink reference signal from the source network node 310.

As shown by reference number 365, upon successfully establishing a connection with the target network node 315 (e.g., via a random access procedure) during the handover execution phase 335, the UE 305 may transmit an RRC reconfiguration completion message to the target network node 315. Reception of the RRC reconfiguration message by the target network node 315 may trigger the start of the handover completion phase 340.

As shown by reference number 370, during the handover completion phase 340, the source network node 310 and the target network node 315 may communicate with one another to prepare for release of the connection between the source network node 310 and the UE 305. In some aspects, the target network node 315 may determine that a connection between the source network node 310 and the UE 305 is to be released, such as after receiving the RRC reconfiguration message from the UE 305. In this case, the target network node 315 may transmit a handover connection setup completion message to the source network node 310. The handover connection setup completion message may cause the source network node 310 to stop transmitting data to the UE 305 and/or to stop receiving data from the UE 305. Additionally, or alternatively, the handover connection setup completion message may cause the source network node 310 to forward communications associated with the UE 305 to the target network node 315 and/or to notify the target network node 315 of a status of one or more communications with the UE 305. For example, the source network node 310 may forward, to the target network node 315, buffered downlink communications (e.g., downlink data) for the UE 305 and/or uplink communications (e.g., uplink data) received from the UE 305. Additionally, or alternatively, the source network node 310 may notify the target network node 315 regarding a PDCP status associated with the UE 305 and/or a sequence number to be used for a downlink communication with the UE 305.

As shown by reference number 375, during the handover completion phase 340, the target network node 315 may transmit an RRC reconfiguration message to the UE 305 to instruct the UE 305 to release the connection with the source network node 310. Upon receiving the instruction to release the connection with the source network node 310, the UE 305 may stop communicating with the source network node 310. For example, the UE 305 may refrain from transmitting uplink communications to the source network node 310 and/or may refrain from monitoring for downlink communications from the source network node 310.

As shown by reference number 380, during the handover completion phase 340, the UE may transmit an RRC reconfiguration completion message to the target network node 315 to indicate that the connection between the source network node 310 and the UE 305 is being released or has been released.

As shown by reference number 385, during the handover completion phase 340, the target network node 315, the UPF device 320, and/or the AMF device 325 may communicate to switch a user plane path of the UE 305 from the source network node 310 to the target network node 315. Prior to switching the user plane path, downlink communications for the UE 305 may be routed through the core network to the source network node 310. After the user plane path is switched, downlink communications for the UE 305 may be routed through the core network to the target network node 315. Upon completing the switch of the user plane path, the AMF device 325 may transmit an end marker message to the source network node 310 to signal completion of the user plane path switch. As shown by reference number 390, the target network node 315 and the source network node 310 may communicate to release the source network node 310.

As part of the L3 handover procedure, the UE 305 may maintain simultaneous connections with the source network node 310 and the target network node 315 during a time period 395. The time period 395 may start at the beginning of the handover execution phase 335 (e.g., upon reception by the UE 305 of a handover command from the source network node 310) when the UE 305 performs a random access procedure with the target network node 315. The time period 395 may end upon release of the connection between the UE 305 and the source network node 310 (e.g., upon reception by the UE 305 of an instruction, from the target network node 315, to release the source network node 310). By maintaining simultaneous connections with the source network node 310 and the target network node 315, the handover procedure can be performed with zero or a minimal interruption to communications, thereby reducing latency.

As indicated above, FIG. 3 is provided as an example. Other examples may differ from what is described with regard to FIG. 3.

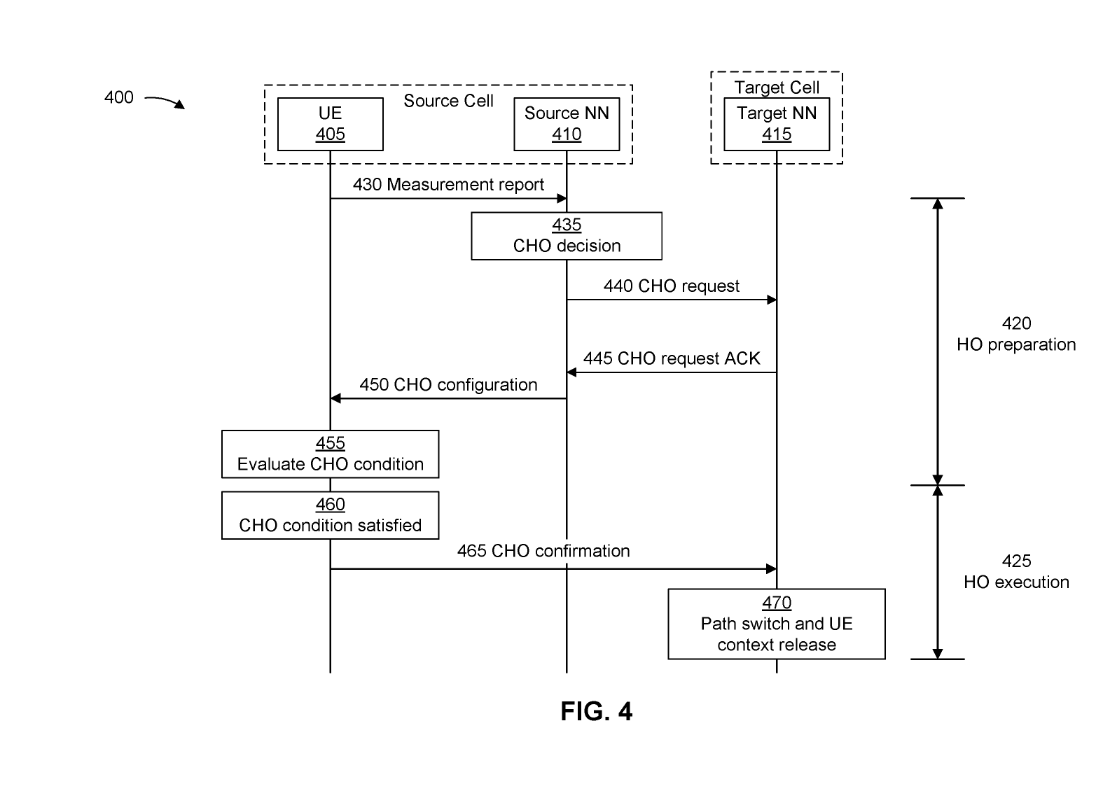

FIG. 4 is a diagram illustrating an example 400 of a CHO procedure in accordance with the present disclosure. As shown in FIG. 4, the CHO procedure may involve a UE 405, a source network node 410, and a target network node 415. In some examples, actions described as being performed by a network node may be performed by multiple network nodes. The UE 405 and the source network node 410 may be connected (e.g., may have an RRC connection) via a serving cell or a source cell, and the UE 405 may undergo a CHO to the target network node 415 via a target cell.

As shown in FIG. 4, the CHO procedure may include a handover preparation phase 420 and a handover execution phase 425. During the handover preparation phase 420, the source network node 410 may prepare one or more candidate target cells in advance, and may send a CHO configuration to the UE 405 when radio conditions between the UE 405 and the source network node 410 are not degraded. When the CHO configuration is received, the UE 405 stores a CHO message, and applies the stored CHO message only when a configured condition is satisfied for a configured candidate target cell. During the handover execution phase 425, the UE 405 may execute the handover by performing a random access procedure with the target network node 415 and establishing an RRC connection with the target network node 415 based on a configured condition being satisfied for the target network node 415. Accordingly, as described herein, the CHO procedure may reduce handover failure occurrences (e.g., where a handover is not triggered because a measurement report transmitted by the UE 405 does not reach the source network node 410 and/or because a handover command transmitted by the source network node 410 does not reach the UE 405 due to degraded signal conditions between the UE 405 and the source network node 410).

For example, as shown by reference number 430, during the handover preparation phase 420, the UE 405 may transmit, and the source network node 410 may receive, a measurement report that indicates measurements related to a signal strength (e.g., RSRP measurements, RSSI measurements, RSRQ measurements, and/or CQI values) or other suitable measurements associated with the source cell and/or one or more neighboring cells. In some examples, as shown by reference number 435, the source network node 410 may configure a CHO based on the measurement report provided by the UE 405 or other suitable information. For example, as shown by reference number 440, the source network node 410 may transmit a CHO request to the target network node 415 to instruct the target network node 415 to prepare for a potential handover. The source network node 410 may communicate RRC context information associated with the UE 405 and/or configuration information associated with the UE 405 to the target network node 415. The target network node 415 may prepare for the potential handover by reserving resources for the UE 405. After reserving the resources, as shown by reference number 445, the target network node 415 may transmit an ACK in response to the CHO request to the source network node 410.

As further shown by reference number 450, the source network node 410 may transmit, and the UE 405 may receive, a CHO configuration. For example, in some aspects, the CHO configuration may include a handover command to trigger a handover from the source network node 410 to the target network node 415, and the CHO configuration may further indicate one or more conditions associated with the CHO command. Accordingly, the UE 405 may generally store the CHO command, and may execute the CHO command only when an associated condition is satisfied. For example, in some aspects, the one or more conditions may instruct the UE 405 to execute the CHO command when a measurement associated with the source network node 410 fails to satisfy a threshold, when a difference between a measurement associated with the target network node 415 and a measurement associated with the source network node 410 satisfies a threshold, when a measurement associated with the target network node 415 satisfies a threshold, and/or when a measurement associated with the source network node 410 fails to satisfy a first threshold and a measurement associated with the target network node 415 satisfies a second threshold, among other examples.

Accordingly, as shown by reference number 455, the UE 405 may evaluate the CHO condition indicated by the source network node 410. For example, the UE 405 may obtain a measurement associated with the source network node 410 and/or a measurement associated with the target network node 415, and may determine whether the measurement associated with the source network node 410 and/or the measurement associated with the target network node 415 satisfy the condition associated with the CHO command. In cases where the condition associated with the CHO command is not satisfied, the UE 405 does not execute the CHO command, and may re-evaluate the condition associated with the CHO command at a later time. Alternatively, as shown by reference number 460, the UE 405 may determine that the condition associated with the CHO command is satisfied. In such cases, as shown by reference number 465, the UE 405 executes the CHO command, and communicates with the target network node 415 to confirm the CHO. As shown by reference number 470, the target network node 415 may perform a path switch to switch a user plane path of the UE 405 from the source network node 410 to the target network node 415. Prior to switching the user plane path, downlink communications for the UE 405 may be routed through the source network node 410. After the user plane path is switched, downlink communications for the UE 405 may be routed through the target network node 415. Upon completing the switch of the user plane path, a core network node may transmit an end marker message to the source network node 410 o signal completion of the user plane path switch, and the target network node 415 may communicate with the source network node 410 to release a context associated with the UE 405 at the source network node 410.

As indicated above, FIG. 4 is provided as an example. Other examples may differ from what is described with regard to FIG. 4.

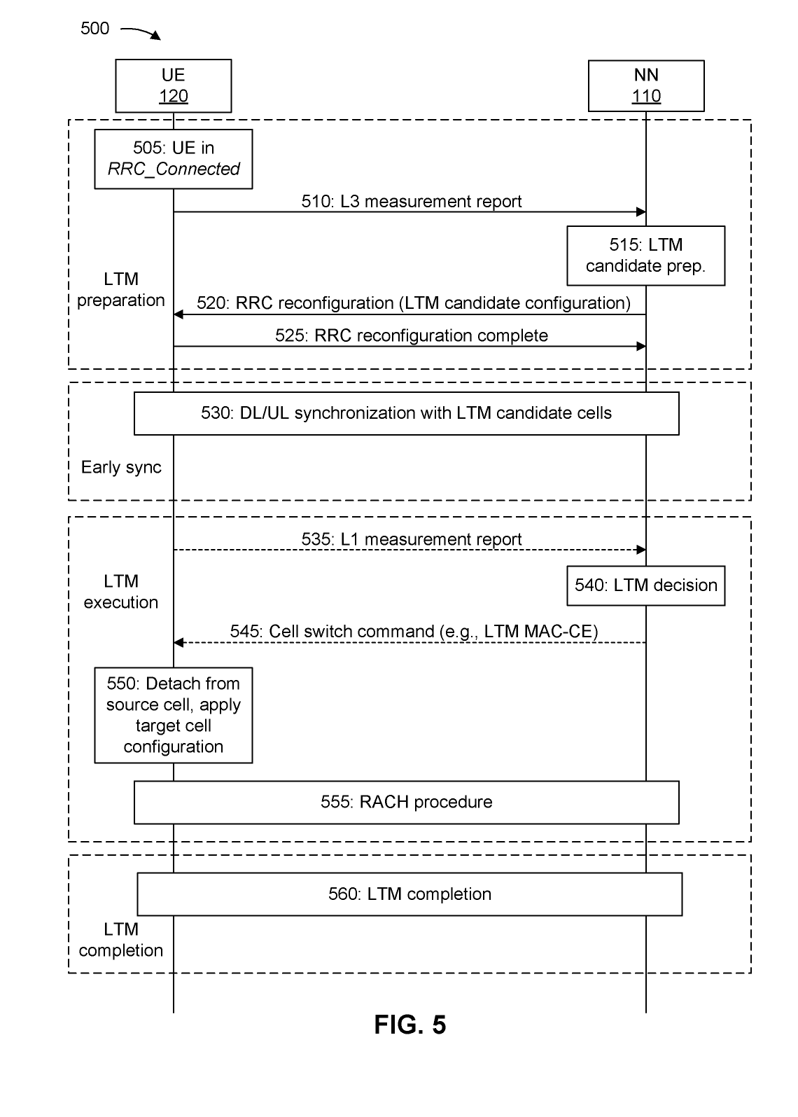

FIG. 5 is a diagram illustrating an example 500 of an LTM procedure, in accordance with the present disclosure. As shown in FIG. 5, example 500 includes communication between a network node 110 and a UE 120. In some aspects, the network node 110 and the UE 120 may communicate in a wireless network, such as wireless network 100. The network node 110 and the UE 120 may communicate via a wireless access link, which may include an uplink and a downlink.

In some examples, the network node 110 may instruct the UE 120 to change or switch serving cells, such as when the UE 120 moves away from coverage of a current serving cell (sometimes referred to as a source cell) and towards coverage of a neighboring cell (sometimes referred to as a target cell). In some cases, the network node 110 may instruct the UE 120 to change cells using a L3 handover procedure, such as the L3 handover procedure shown in FIG. 3, which may be referred to herein as a legacy handover procedure. In an L3 handover procedure, the network node 110 may transmit, to the UE 120, an RRC reconfiguration message indicating that the UE 120 is to perform a handover procedure to a target cell. For example, the network node 110 may transmit the reconfiguration message triggering the handover to the target cell in response to the UE 120 providing the network node 110 with an L3 measurement report indicating signal strength measurements associated with one or more cells (e.g., measurements associated with the source cell and/or one or more neighboring cells). In response to the RRC reconfiguration message, the UE 120 may communicate with the source cell and the target cell to detach from the source cell and connect to the target cell (e.g., the UE 120 may perform a contention-free RACH procedure in the target cell to establish an RRC connection with the target cell in accordance with a contention-free random access (CFRA) configuration indicated in the RRC reconfiguration message). Once handover is complete, the target cell may communicate with a UPF of a core network to instruct the UPF to switch a user plane path of the UE 120 from the source cell to the target cell. The target cell may also communicate with the source cell to indicate that handover is complete and that the source cell may be released.

As described herein, L3 handover procedures may be associated with high latency and high overhead due to the multiple RRC reconfiguration messages and/or other L3 signaling and operations used to perform the handover procedures. Accordingly, in some examples, a UE 120 may be configured to perform an LTM procedure, such as the LTM procedure shown in FIG. 5, which uses L1/L2 signaling to significantly reduce a handover latency relative to a legacy L3 handover procedure. For example, as shown in FIG. 5, the LTM procedure may include an LTM preparation phase, an early synchronization phase (shown as “early sync” in FIG. 5), an LTM execution phase, and an LTM completion phase.

As shown by reference number 505, during the LTM preparation phase, the UE 120 may be in an RRC connected state (sometimes referred to as RRC_Connected) with a source cell provided by the network node 110. As shown by reference number 510, the UE 120 may transmit, and the network node 110 may receive, an L3 measurement report (sometimes referred to as a MeasurementReport), which may indicate measurements related to a signal strength (e.g., RSRP measurements, RSSI measurements, RSRQ measurements, and/or CQI values) or other suitable measurements associated with the source cell and/or one or more neighboring cells. In some examples, based at least in part on the L3 measurement report or other information, the network node 110 may configure LTM for UE 120. Accordingly, as shown by reference number 515, the network node 110 may perform LTM candidate preparation. For example, during the LTM candidate preparation, the network node 110 may obtain configuration information for one or more LTM candidate cells (e.g., one or more parameters related to an identity for each LTM candidate cell, a synchronization and/or measurement configuration for each LTM candidate cell, and/or a full RRC configuration message associated with each LTM candidate cell, among other examples).

As shown by reference number 520, the network node 110 may transmit, and the UE 120 may receive, an RRC reconfiguration message (sometimes referred to as an RRCReconfiguration message), which may include an LTM configuration. More particularly, the LTM configuration included in the RRC reconfiguration message may indicate the configuration information for one or more LTM candidate cells (e.g., obtained during the LTM candidate preparation), which may be candidate cells to become a serving cell of the UE 120 and/or cells for which the UE 120 may later be triggered to perform an LTM procedure. As shown by reference number 525, the UE 120 may store the configuration information for the one or more LTM candidate cells and may transmit, in response to the RRC reconfiguration message, an RRC reconfiguration complete message (sometimes referred to as an RRCReconfigurationComplete message) to the network node 110.

As shown by reference number 530, during the early synchronization phase, the UE 120 may optionally perform downlink synchronization and/or uplink synchronization with the LTM candidate cells associated with the one or more LTM candidate cell configurations. For example, the UE 120 may perform downlink synchronization and timing advance acquisition with the one or more LTM candidate cells prior to receiving an LTM cell switch command. In some aspects, performing the early synchronization with the one or more candidate cells may reduce latency associated with performing a RACH procedure later in the LTM procedure, which is described in more detail below in connection with reference number 555. For example, the UE 120 may acquire the timing advance for an LTM candidate cell in accordance with a measured timing advance indicated in the configuration information for the LTM candidate cell and/or by using PRACH transmission parameters indicated in the configuration information (e.g., in an early synchronization configuration, which may be provided in an EarlyUL-SyncConfig parameter) to transmit a PRACH to the LTM candidate cell.

As shown by reference number 535, during the LTM execution phase, the UE 120 may obtain L1 measurements associated with the configured LTM candidate cells, and may transmit, to the network node 110, one or more L1 measurement reports associated with the configured LTM candidate cells. As shown by reference number 540, based at least in part on the L1 measurement report(s), the network node 110 may decide to execute an LTM cell switch to an LTM target cell (e.g., included among the configured LTM candidate cells). Accordingly, as shown by reference number 545, the network node 110 may transmit, and the UE 120 may receive, a MAC-CE or another suitable L1 or L2 message triggering an LTM cell switch (e.g., the message triggering the LTM cell switch may be referred to herein as a cell switch command, an LTM cell switch command MAC-CE, a MAC-CE carrying a cell switch command, or the like). The cell switch command may indicate a candidate configuration index associated with the LTM target cell. As shown by reference number 550, based at least in part on the cell switch command, the UE 120 may switch to the configuration of the LTM target cell (e.g., the UE 120 may detach from the source cell and apply the configuration of the LTM target cell). Moreover, as shown by reference number 555, the UE 120 may perform a RACH procedure towards the LTM target cell, such as when a timing advance associated with the target cell is not available (e.g., in cases in which the UE 120 did not perform the early synchronization described above in connection with reference number 530 and/or the LTM cell switch command does not indicate a valid timing advance for the LTM target cell).

As shown by reference number 560, during the LTM completion phase, the UE 120 may indicate successful completion of the LTM cell switch towards the LTM target cell. In this way, a cell switch or handover to a target cell may be performed using L1/L2 signaling, which is associated with less overhead than an L3 handover procedure and/or a reduced latency relative to an L3 handover procedure.

As indicated above, FIG. 5 is provided as an example. Other examples may differ from what is described with regard to FIG. 5.

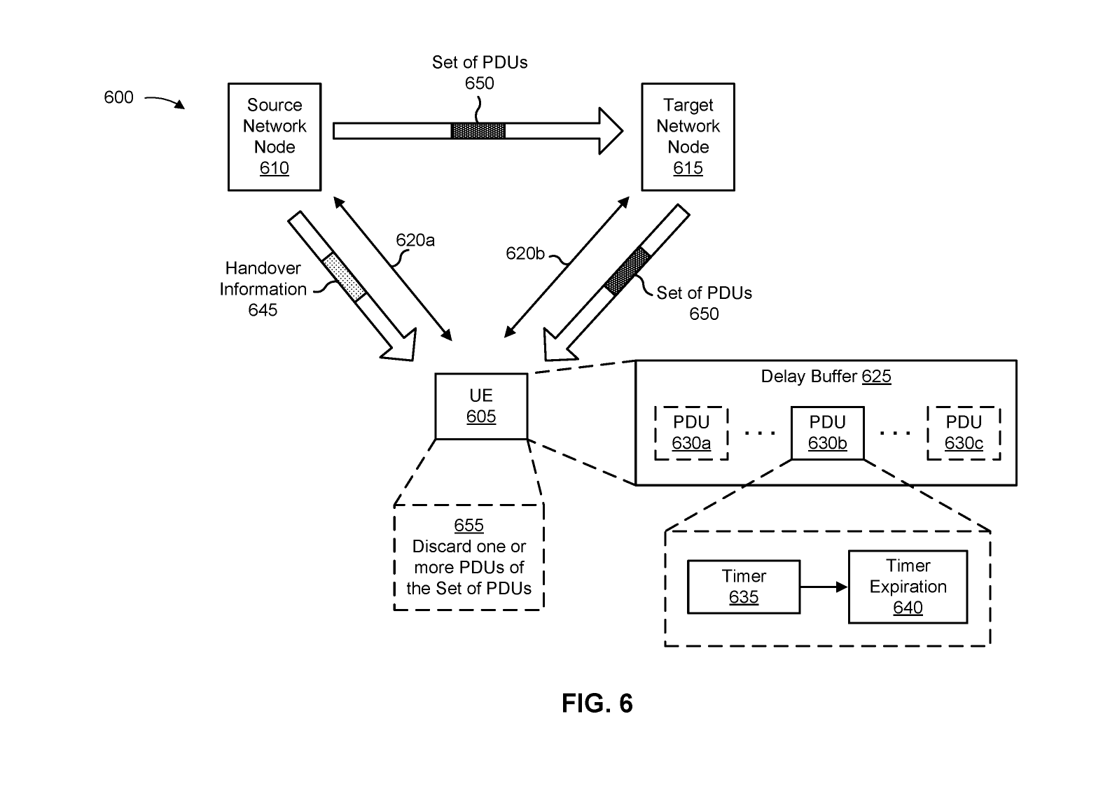

FIG. 6 is a diagram illustrating an example 600 associated with a UE 605 discarding expired data packets after handover in accordance with the present disclosure. In some examples, example 600 may implement or may be implemented by one or more aspects of wireless communication network 100, network node architecture 200, example 300, example 400, or example 500. As shown in FIG. 6, example 600 includes a UE 605, which may correspond to the UE 120 described elsewhere herein. Additionally, the source network node 610 and/or the target network node 615 may correspond to the network node 110 described elsewhere herein.

As shown in FIG. 6, the UE 605 and the source network node 610 may communicate via a wireless link 620a. In some examples, the wireless link 620a may be associated with a wireless wide area network (WWAN) RAT. For example, the wireless link 620a may be a wireless access link that may facilitate uplink and/or downlink communications between the UE 605 and the source network node 610.

In accordance with wireless communications via the wireless link 620a, the UE 605 may receive, and the source network node 610 may transmit, data. For example, the source network node 610 may transmit PDUs to the UE 605 in accordance with the PDCP. The PDU transmission process may be initiate at a PDCP layer associated with the source network node 610, where service data units (SDUs) (typically in the form of Internet Protocol (IP) packets from higher layers) arrive for processing. The SDUs undergo several processes to increase data integrity, security, and efficient transmission. For example, the PDCP layer at the source network node 610 may apply header compression techniques (e.g., robust header compression (ROHC)) to reduce overhead. Additionally, the data of the SDUs may be encrypted to maintain confidentiality, and integrity protection may be applied to control plane information to increase security. The PDCP layer of the source network node 610 may additionally assign each SDU a unique PDCP sequence number, which facilitates packet reordering and duplicate packet detection at the receiving UE 605.

In accordance with applying the several processes to the SDUs, the PDCP layer at the source network node 610 may encapsulate each SDU into a PDCP PDU, adding a header that includes information such as the sequence number. The source network node 610 may pass the PDCP PDUs to the RLC layer, where the PDCP PDUs may be segmented or concatenated according to one or more conditions of the PHY layer. Depending on the mode (such as an RLC acknowledged mode (AM) for reliable delivery or an RLC unacknowledged mode (UM) for less critical data), the RLC layer ensures appropriate handling before forwarding the PDCP PDUs to a MAC layer of the source network node 610. In some examples, the MAC layer of the source network node 610 may manage scheduling, resource allocation, and multiplexing of PDUs from various bearers, preparing the PDUs for transmission over the air interface via the PHY layer.

The source network node 610 may modulate the PDUs (in accordance with the PHY layer) into radio signals and transmit the PDUs to the UE 605 using the allocated frequency and time resources. Upon receiving the transmitted radio signals, a PHY layer at the UE 605 may demodulate the radio signals and pass the demodulated data to a MAC layer of the UE 605, which demultiplexes and forwards the PDUs to the RLC layer of the UE 605. The RLC layer of the UE 605 may reassemble the PDUs and may handle any retransmissions or reordering of the PDUs. Additionally, the PDCP layer at the UE 605 may use the respective sequence numbers with the PDUs to ensure proper reordering, decompress headers of the PDUs, and decrypt the data before delivering the SDUs to the upper layers.

As illustrated in FIG. 6, the UE 605 may store one or more PDUs received from the network node in a delay buffer 625. For example, the delay buffer 625 may be a de-jitter buffer (e.g., for Voice over New Radio (VoNR) traffic, XR traffic, or the like), which the UE 605 may use to manage variations in the arrival times of PDUs received from the source network node 610, ensuring smooth and continuous playback of data (e.g., video, audio, pose, scene, among other examples). In accordance with real-time communication services (such as VoNR or XR), PDUs may be associated with a low latency metric such that delays, jitter, or packet loss may result in choppy or distorted data processing. Therefore the delay buffer 625 at the UE 605 addresses issues associated with packet delays by temporarily storing incoming PDUs to account for any irregularities in PDU arrival times. The irregularities (such as jitter) may occur due to network conditions, such as variable latency caused by congestion, interference, or differences in transmission paths between the UE 605 and the source network node 610.

Therefore, the delay buffer 625 may hold PDUs, received from the source network node 610, for a duration to allow for any delayed packets to arrive and be played in the correct sequence. For instance, in example 600, the UE 605 may receive a PDU 630b from the source network node 610 that is associated with a sequence of PDUs, where the sequence of PDUs may be associated with a sequence of data meant for consecutive playback at the UE 605. Additionally, the UE 605 may receive one or more PDUs from the sequence of PDUs out of order. For example, PDU 630b may be associated with a sequence number that is not a starting sequence number for the sequence of PDUs. In other words, based on the sequence number for PDU 630b not being the starting sequence number, the UE 605 may wait to receive one or more PDUs with respective sequence numbers that are lower (e.g., earlier) than the sequence number for PDU 630b (such as a PDU 630a). Additionally, the UE 605 may wait for one or more PDUs with respective sequence number greater (e.g., later) than the sequence number for PDU 630b (such as a PDU 630c).

By using the delay buffer 625, the UE 605 may wait a duration to receive one or more PDUs of the sequence of PDUs (such as PDU 630a) before processing the sequence of PDUs. In some examples, the duration that the UE 605 waits may be based on a timer 635 associated with PDU 630b. For example, the UE 605 may initiate the timer 635 in accordance with receiving the PDU 630b. If the UE 605 receives the PDU 630a before a timer expiration 640 of the timer 635, then the UE 605 may process the PDU 630 and, 630b. If, however, the UE 605 does not receive PDU 630a before the timer expiration 640, then the UE 605 may remove the PDU 630b from the delay buffer 625 and discard PDU 630a if received after the timer expiration 640.

Therefore, the timer 635 may enable a balance between reducing delay for PDU processing at the UE 605 and preventing PDU loss. For example, if the timer 635 is too short, delayed packets may be discarded, leading to gaps in data processing. Alternatively, if the timer 635 is too long, the overall latency may increase, affecting real-time communication. Therefore, a duration associated with the timer 635 may be based on the type of data included in the PDUs stored in the delay buffer. In some examples, the timer 635 may be based on network conditions. For instance, if a signal quality associated with wireless link 620a does not satisfy a threshold, then the UE may increase the duration of the timer to account for low signal quality. Additionally, or alternatively, if there is a known delay associated with network conditions (e.g., the source network node 610 is associated with a satellite network), then the duration associated with the timer 635 may increase to account for the network conditions. In some examples, the UE 605 may determine the duration of the timer 635 based on a latency metric associated with the PDUs stored at the delay buffer 625. For instance, if the PDU 630b is associated with a first latency that satisfies a threshold (e.g., a relatively low latency allowance), then the timer 635 may be a first duration and if the PDU 630b is associated with a second latency that does not satisfy the threshold (e.g., a relatively high latency allowance), then the timer 635 may be a second duration that is greater than the first duration. In some examples, the duration of the timer 635 may be based on an application associated with the PDUs. For instance, the source network node 610 and UE 605 may communicate the PDUs in accordance with communicating data for an application running at the UE 605 (such as one or more of audio streaming, video streaming, augmented reality (AR), XR, short message service (SMS) messaging, or voice communications). For example, the timer 635 may be associated with an application play time expiration. Therefore, the duration of the timer 635 may be based on the type of application associated with the PDUs. In some examples, the application may indicate the duration of the timer 635 to the UE 605. In some examples, the UE 605 may be configured with a set of durations and may select the duration based on the type of application associated with a PDU. By dynamically managing the storage and discarding or processing of PDUs, the delay buffer 625 increases the likelihood of the UE 605 processing PDUs in a consecutive order, improving user experience by ensuring that the data of the PDUs is processed in a consistent and ordered steam.

In some examples, the UE 605 may operate in accordance with a handover procedure. For example, the UE 605 may establish a wireless link 620b with the target network node 615 and may additionally release wireless link 620a. In some examples, wireless link 620b may be associated with a WWAN RAT. For example, the wireless link 620b may be a cellular link that may facilitate uplink and/or downlink communications between the UE 605 and the target network node 615. In some examples, the UE 605 may perform the handover from the source network node 610 to the target network node 615 in accordance with one or more of the techniques of FIGS. 3-5. For example, the UE 605 may perform the handover to the target network node 615 in accordance with an L3 handover procedure, in accordance with a CHO procedure, or in accordance with an LTM procedure.

Additionally, the UE 605 may perform the handover in accordance with receiving, from the source network node 610, handover information 645. In some examples, the handover information 645 may be indicated via control signaling (e.g., an RRCReconfiguration message). For example, in accordance with L3 handover, the handover information 645 may be associated with reference number 355 (e.g., included in an RRCReconfiguration message, which may include a handover command). In accordance with CHO, the handover information 645 may be associated with reference number 450 (e.g., included in an RRCReconfiguration message, which may include a CHO configuration). In accordance with the LTM procedure the handover information 645 may be associated with reference number 520 (e.g., included in an RRCReconfiguration message, which may include an LTM configuration). Therefore, the UE 605 may perform the handover procedure in accordance with the handover information 645.

In some examples, the handover procedure may be a sequence handover. For example, as part of the handover information 645, the source network node 610 may indicate a set of target network nodes that the UE 605 may attempt to perform the handover with. As such, if the UE 605 fails to establish a wireless link 620 with a first target network node of the set of target network nodes, the UE 605 may perform a subsequent handover procedure with a second target network node of the set of target network nodes. Therefore, in accordance with sequence handover, the UE 605 may attempt respective handover procedures with the set of target network nodes until the UE 605 successfully establishes a wireless link with one of the target network nodes. In accordance with sequence handover, the UE 605 may attempt to establish a wireless link multiple times in accordance with a receiving the handover information 645. Therefore sequence handover may reduce signaling overhead between the UE 605 and the source network node 610.

In some examples, the handover procedure may be a non-sequence handover. For example, as part of the handover information 645, the source network node 610 may indicate a single target network node for the UE 605 to perform handover to. Therefore, the UE 605 may perform handover with the single target network node indicated in the handover information 645. If the UE 605 is unable to establish a wireless link with the single target network node, then the UE 605 may transmit to the source network node 610, and the source network node 610 may receive a feedback communication associated with the unsuccessful handover. In some examples, the feedback communication may indicate a cause for the unsuccessful handover (e.g., one or more of signal quality does not satisfy a threshold, insufficient resources associated with the target network node 615, handover timing issues, an radio link failure (RLF) indication, interference of neighboring network nodes, handover parameter misconfiguration, or mobility of the UE 605). In accordance with the cause of the unsuccessful handover, the source network node 610 may determine another target network node for the UE 605 to handover to, and transmit to the UE 605 an indication of the determined target network node. Therefore, the UE 605 may attempt to handover to the determined target network node. In accordance with non-sequence handover, the UE 605 and the source network node 610 may communicate and adapt to the conditions of the wireless environment, which may reduce latency for handover in wireless networks associated with rapidly changing wireless conditions.

In accordance with successful handover of the UE 605 from the source network node 610 to the target network node 615, the source network node 610 may forward data, scheduled for reception by the UE 605, to the target network node 615. For example, the source network node 610 may transmit a set of PDUs 650 to the target network node 615. Therefore, the target network node 615 may transmit, and the UE 605 may receive, the set of PDUs 650.

In some cases, however, the handover procedure may cause a data interruption during which the UE 605 does not receive any PDUs from the source network node 610 or the target network node 615. For example, there may be latency associated with performing the handover to the target network node 615 and establishing the wireless link 620b (e.g., based on a time for the UE to apply a configuration for the target network node and/or perform uplink and/or downlink synchronization). Additionally, there may be latency associated with the source network node 610 forwarding the set of PDUs 650 to the target network node 615. Therefore, the UE 605 may receive one or more PDUs of the set of PDUs 650 at a time later than anticipated. In some examples, delay of one or more PDUs may disrupt the flow of the UE 605 processing PDUs stored at the delay buffer 625. For example, if the set of PDUs 650 includes the PDU 630a, the timer expiration 640 of the timer 635 may occur before the UE 605 receives the set of PDUs 650. In such an example, the UE 605 may receive the PDU 630a, but refrain from processing the PDU 630a at the delay buffer 625 based on the timer expiration 640. Therefore, the UE 605 may perform operation 655, where the UE 605 discards the PDU 630a.

Despite the timer expiration 640 the UE 605 may still receive and decode the PDU 630a which may increase signaling overhead between the UE 605 and the target network node 615 and increase power expenditure at the UE 605. Additionally, discarding PDUs may further consume power at the UE 605. Additionally, transmitting PDUs that may be discarded by the UE 605 may increase the usage of Uu resources, which may cause interference at the network and/or the UE 605. Additionally, prior to transmission of the set of PDUs 650, the target network node 615 may process the set of PDUs 650 in accordance with the PDCP. Therefore, processing PDUs that the UE 605 may discard may increase a duration of data interruption associated with performing the handover procedure.

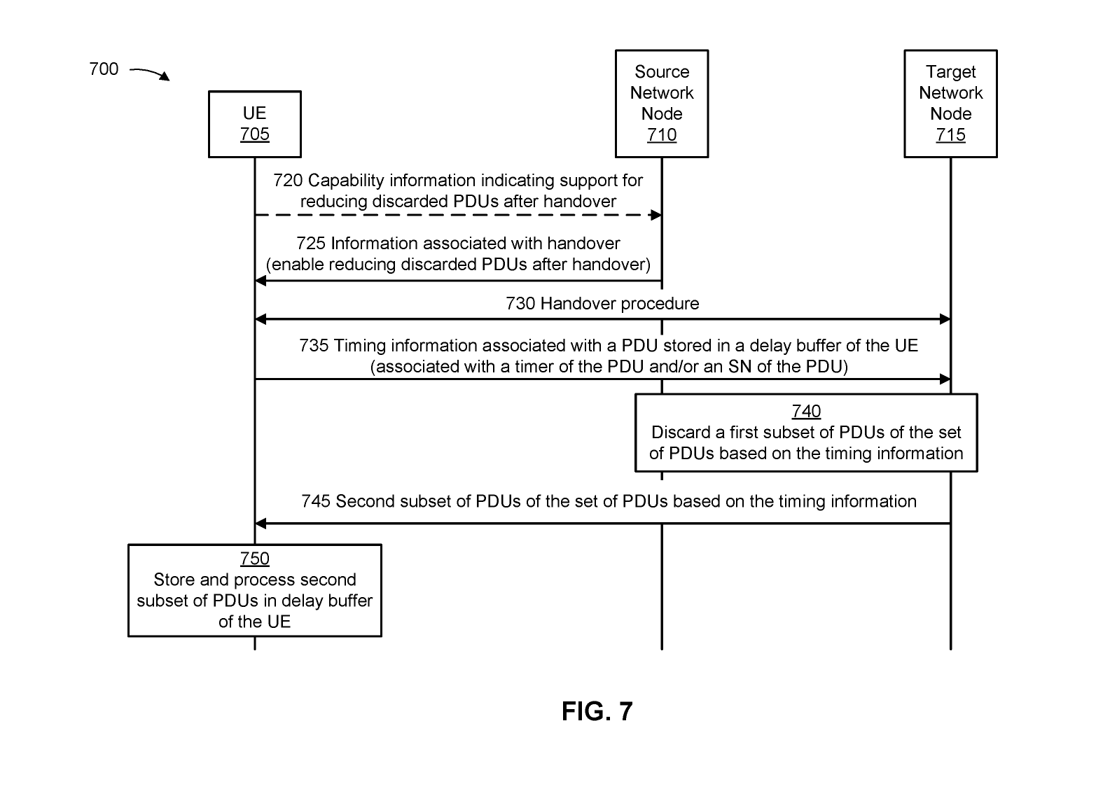

Various aspects of the present disclosure may reduce a quantity of PDUs discarded by the UE 605. For example, the UE 605 may transmit, and the target network node 615 may receive, timing information associated with one or more PDUs stored at a delay buffer 625 of the UE 605. For example, the timing information may include information associated with expiration of the timer 635 associated with PDU 630b and/or the sequence number associated with PDU 630b. In accordance with the timing information, the target network node 615 may determine whether one or more PDUs scheduled for transmission to the UE 605 may expire before reception by the UE 605. Therefore, the target network node 615 may discard one or more PDUs predicted to expire. In other words, the target network node 615 may refrain from transmitting PDUs to the UE 605 in accordance with the timing information indicated by the UE 605. Further description of the reducing PDUs discarded by the UE 605 after handover is provided herein, including with reference to FIG. 7.

As indicated above, FIG. 6 is provided as an example. Other examples may differ from what is described with regard to FIG. 6.

FIG. 7 is a diagram illustrating an example 700 of reducing discarded data packets after handover in accordance with the present disclosure. Example 700 may implement or be implemented by one or more aspects of wireless communication network 100, network node architecture 200, wireless communication network 300, example 400, example 500, or example 600. For instance, example 700 includes wireless communications between a UE 705, a source network node 710, and a target network node 715. In some examples, the UE 705 may correspond to the UE 120 described elsewhere herein. Additionally, the source network node 710 and/or the target network node 715 may correspond to the network node 110 described elsewhere herein. Alternative examples of the following may be implemented, where some operations are performed in a different order than described, or not described at all. In some cases, one or more operations may include additional features not mentioned below, or further operations may be added. In addition, while example 700 shows operations between the UE 120 and one or more network nodes 110, the communication may occur between any quantity of network devices of various types described herein.

In a first operation 720, the UE 705 may transmit, and the source network node 710 may receive, capability information. For example, the capability information may indicate support by the UE 705 for reducing discarded PDUs after handover. In other words, the capability information may indicate that the UE 705 is capable of indicating timing information associated with one or more PDUs stored at a delay buffer of the UE 705 (such as delay buffer 625) to assist in the reducing a quantity of PDUs that would be discarded by the UE 705 upon reception based on an expiration at the delay buffer (such as the timer expiration 640 of the timer 635).

In a second operation 725, the UE 705 may receive, and the source network node 710 may transmit, information associated with handover. For example, the information may be associated with a handover from the source network node 710 to the target network node 715. In some examples, the information associated with handover may correspond to the handover information 645. Additionally, the information associated with handover may include an indication that enables and/or configures the UE 705 to reduce discarded PDUs after handover. In some examples, the UE 705 is enabled and/or configured to reduce discarded PDUs after handover in accordance with the capability information associated with the first operation 720. In other words, the information associated with the handover may include the handover information 645 (associated with an L3 handover procedure, a CHO procedure, or an LTM procedure) and may include the indication that enables and/or configures the UE 705 to reduce discarded PDUs after the handover. In some other examples, the UE 705 may receive, and the source network node 710 may transmit, the indication that enables and/or configures the UE 705 to reduce discarded PDUs after the handover in control signaling separate from the handover information 645 (e.g., via separate RRC signaling, via a MAC-CE, or via DCI).

In a third operation 730, the UE 705 and the target network node 715 may perform a handover procedure. For example, the UE 705 and the target network node 715 may perform the handover procedure in accordance with the information associated with the handover, as received in the second operation 725. That is, the handover procedure may be an L3 handover procedure, a CHO procedure, or an LTM procedure. Additionally, the handover procedure may be a sequence handover procedure or a non-sequence handover procedure, as described with reference to FIG. 6.

In a fourth operation 735, the UE 705 may transmit, and the target network node 715 may receive, timing information associated with a PDU stored at the delay buffer of the UE 705. For example, the timing information may be associated with a PDU (such as the PDU 630b) that is associated with a set of PDUs scheduled for transmission to the UE 705 (such as the set of PDUs 650), where the UE 705 transmits the timing information based on a timer associated with the PDU (such as timer 635). Additionally, as part of the fourth operation 735, the UE 705 may transmit, and the target network node 715 may receive, a request for the target network node 715 to discard one or more PDUs from the set of PDUs based on the timing information associated with the PDU.

In some examples, the timing information associated with the PDU includes a sequence number associated with the PDU based on a state of the timer associated with the PDU. In some examples, inclusion of the sequence number in the timing information may indicate to the target network node 715 that the PDU associated with the sequence number has expired. For example, with reference to FIG. 6, if the timing information includes the sequence number associated with PDU 630b, then the target network node 715 may determine that the timer 635 associated with PDU 630b has expired. In some examples, an application layer associated with the UE 705 may determine whether the timer has expired and may indicate the sequence number associated with the expired timer to a radio layer of the UE 705. Based on the sequence number indicating that the associated PDU has expired, the UE 705 may refrain from explicitly indicating a state of the timer in addition to the sequence number, which may reduce signaling overhead associated with the timing information.

In some examples, the timing information associated with the PDU includes a sequence number associated with the PDU and an indication that a remaining time associated with the timer for the PDU fails to satisfy a threshold. In some examples, the threshold may be associated with PDCP deadline. For example, the indication of the remaining time may indicate, to the target network node 715, a duration the UE 705 is requesting to receive PDUs by to avoid expiration of the timer. In some examples, the PDCP deadline may account for one or more of receiving and demodulating the PDUs, a PDCP processing time at the UE 705 associated with the PDUs, or a time associated with storing the received PDUs to the delay buffer. Therefore, the PDCP deadline may ensure that the UE 705 has enough time to receive and process the PDUs before expiration of the timer. Additionally, the PDCP deadline may be associated with an application latency parameter. For example, if the set of PDUs scheduled for transmission to the UE 705 are associated with an application operating at the UE 705, the PDCP deadline may satisfy one or more latency metrics associated with the application. In some examples, the application layer of the UE 705 may determine the PDCP deadline and indicate the PDCP deadline and the associated sequence number to the radio layer associated with the UE 705. Therefore the timing information may indicate the sequence number and the PDCP deadline.

In some examples, the UE 705 may transmit, and the target network node 715 may receive, the timing information associated with PDU and the request via RRC signaling that indicates that the handover is complete. For example, the timing information and the request may be associated with one or more of reference number 380 (e.g., included in the RRC reconfiguration completion message), reference number 465 (e.g., included in the confirmation of the CHO), or reference number 560 (e.g., included in the indication of successful completion of LTM cell switch). In some examples, the timing information and the request may be associated with an information element of the RRC signaling.

In some examples, the UE 705 may transmit, and the target network node 715 may receive, the timing information associated with PDU and the request via a MAC-CE. For example, the timing information and the request may be indicated in control signaling separate from the RRC signaling that indicates handover is complete.

In a fifth operation 740, the source network node 710 and/or the target network node 715 may discard a first subset of PDUs of the set of PDUs scheduled for the UE 705 based on the timing information.

In some examples, the target network node 715 may determine and discard the first subset of PDUs. For example, the target network node 715 may receive, and the source network node 710 may send, the set of PDUs scheduled for transmission to the UE 705. In accordance with the timing information, the target network node 715 may determine a respective set of predicted timers for the set of PDUs based on the sequence number of the PDU and the state of the timer. For example, if the timing information indicated that the timer associated with the PDU had expired, then the target network node 715 may determine that PDUs of the set of PDUs associated with respective sequence numbers that are lower than the sequence number associated with the expired PDU have also expired. Therefore, the target network node 715 may determine that the PDUs associated with predicted timers that are expired are included in the first subset of PDUs and that PDUs associated with predicted timers that are not expired are included in a second subset of PDUs.

Additionally, or alternatively, if the timing information indicates the sequence number and the PDCP deadline associated with the PDU, then the target network node 715 may predict (e.g., via AI and/or ML) which PDUs of the set of PDUs are likely to expire by the time the UE 705 is able to receive and process the PDUs in accordance with the PDCP deadline. In some examples, the target network node 715 may determine a respective set of predicted timers for the set of PDUs in accordance with the sequence number and the PDCP deadline indicated in the timing information. Therefore, the target network node 715 may determine that the PDUs associated with predicted timers that do not satisfy the PDCP deadline are included in the first subset of PDUs and that PDUs associated with predicted timers that do satisfy the PDCP deadline are included in the second subset of PDUs. In accordance with determining the first subset of PDUs, the target network node 715 may discard the first subset of PDUs. Discarding the first subset of PDUs may include removing the first subset of PDUs from a buffer at the target network node 715 and refraining from transmitting the first subset of PDUs to the UE 705.

In some examples, the source network node 710 may determine and discard the first subset of PDUs. For example, the target network node 715 may send, and the source network node 710 may receive, the timing information and a request for the source network node 710 to refrain from forwarding PDUs that do not satisfy the timing information. In accordance with the timing information, the source network node 710 may determine a respective set of predicted timers for the set of PDUs based on the sequence number of the PDU and the state of the timer. For example, if the timing information indicated that the timer associated with the PDU has expired, then the source network node 710 may determine that PDUs of the set of PDUs associated with respective sequence numbers that are lower than the sequence number associated with the expired PDU may also be expired. Therefore, the source network node 710 may determine that the PDUs associated with predicted timers that are expired belong to the first subset of PDUs and that PDUs associated with predicted timers that are not expired are included in a second subset of PDUs.

Alternatively, if the timing information indicates the sequence number and the PDCP deadline associated with the PDU, then the source network node 710 may predict which PDUs of the set of PDUs are likely expire by the time the UE 705 is able to receive and process the PDUs in accordance with the PDCP deadline. In some examples, the source network node 710 may determine a respective set of predicted timers for the set of PDUs in accordance with the sequence number and PDCP deadline indicated in the timing information. Therefore, the source network node 710 may determine that the PDUs associated with predicted timers that do not satisfy the PDCP deadline are included in the first subset of PDUs and that PDUs associated with predicted timers that do satisfy the PDCP deadline are included in the second subset of PDUs. In accordance with determining the first subset of PDUs, the source network node 710 may discard the first subset of PDUs. Discarding the first subset of PDUs may include removing the first subset of PDUs from a buffer at the source network node 710 and refraining from transmitting the first subset of PDUs to the source network node 710. Therefore, the source network node 710 may transmit, and the target network node 715 may receive the second subset of PDUs. In some examples, the target network node 715 and source network node 710 may communicate via backhaul resources.

In a sixth operation 745, the UE 705 may receive, and the target network node 715 may transmit, the second subset of PDUs based on the timing information.

In a seventh operation 750, the UE 705 may store the second subset of PDUs in the delay buffer. In accordance with the techniques described herein, the second subset of PDUs may be associated with respective active timers at the UE 705 based on the UE 705 transmitting the timing information to the target network node 715. Therefore, the UE 705 may process the second subset of PDUs in an order corresponding to the sequence numbering and in accordance with the associated application operating at the UE 705.

As indicated above, FIG. 7 is provided as an example. Other examples may differ from what is described with regard to FIG. 7.

FIG. 8 is a diagram illustrating an example process 800 performed, for example, at an UE or an apparatus of an UE, in accordance with the present disclosure. Example process 800 is an example where the apparatus or the UE (e.g., UE 120) performs operations associated with data packet discard reduction for handover procedures.

As shown in FIG. 8, in some aspects, process 800 may include receiving, from a source network node, information associated with a handover from the source network node to a target network node (block 810). For example, the UE (e.g., using reception component 1002 and/or communication manager 1006, depicted in FIG. 10) may receive, from a source network node, information associated with a handover from the source network node to a target network node, as described above.

As further shown in FIG. 8, in some aspects, process 800 may include transmitting, to the target network node after the handover from the source network node to the target network node, information associated with a PDU in a set of PDUs scheduled for transmission to the UE based at least in part on a timer associated with the PDU and a request for the target network node to discard a first subset PDUs of the set of PDUs based at least in part on the information associated with the PDU (block 820). For example, the UE (e.g., using transmission component 1004 and/or communication manager 1006, depicted in FIG. 10) may transmit, to the target network node after the handover from the source network node to the target network node, information associated with a PDU in a set of PDUs scheduled for transmission to the UE based at least in part on a timer associated with the PDU and a request for the target network node to discard a first subset PDUs of the set of PDUs based at least in part on the information associated with the PDU, as described above.

As further shown in FIG. 8, in some aspects, process 800 may include receiving, from the target network node, a second subset of PDUs of the set of PDUs based at least in part on the information (block 830). For example, the UE (e.g., using reception component 1002 and/or communication manager 1006, depicted in FIG. 10) may receive, from the target network node, a second subset of PDUs of the set of PDUs based at least in part on the information, as described above.

Process 800 may include additional aspects, such as any single aspect or any combination of aspects described below and/or in connection with one or more other processes described elsewhere herein.

In a first aspect, process 800 includes transmitting, to the source network node, capability information indicating support for a scheme for reducing discarded PDUs after handover, wherein transmitting the request for the target network node to discard the first subset of PDUs based at least in part on the information associated with the PDU is in accordance with the scheme.

In a second aspect, alone or in combination with the first aspect, receiving the information associated with the handover from the source network node to the target network node comprises receiving an indication to enable the scheme for reducing discarded PDUs after handover based at least in part on the capability information.

In a third aspect, alone or in combination with one or more of the first and second aspects, the information associated with the PDU includes a sequence number associated with the PDU based at least in part on a state of the timer.

In a fourth aspect, alone or in combination with one or more of the first through third aspects, the state of the timer is expired.

In a fifth aspect, alone or in combination with one or more of the first through fourth aspects, the state of the timer is a remaining time failing to satisfy a threshold.

In a sixth aspect, alone or in combination with one or more of the first through fifth aspects, the threshold is associated with a latency parameter that is associated with an application, and wherein the application is associated with the set of PDUs scheduled for transmission to the UE

In a seventh aspect, alone or in combination with one or more of the first through sixth aspects, process 800 includes storing the second subset of PDUs, wherein the second subset of PDUs are associated with a respective plurality of timers that are not expired based at least in part on transmitting the information associated with the PDU.

In an eighth aspect, alone or in combination with one or more of the first through seventh aspects, the information associated with PDU and the request for the target network node to discard a first subset PDUs are transmitted via RRC signaling that indicates the handover is complete.

In a ninth aspect, alone or in combination with one or more of the first through eighth aspects, the information associated with PDU and the request for the target network node to discard a first subset PDUs are transmitted via a MAC-CE.

In a tenth aspect, alone or in combination with one or more of the first through ninth aspects, the handover is a layer 3 handover procedure, an LTM procedure, a CHO procedure, a sequence handover procedure, or a non-sequence handover procedure.

Although FIG. 8 shows example blocks of process 800, in some aspects, process 800 may include additional blocks, fewer blocks, different blocks, or differently arranged blocks than those depicted in FIG. 8. Additionally, or alternatively, two or more of the blocks of process 800 may be performed in parallel.

FIG. 9 is a diagram illustrating an example process 900 performed, for example, at a target network node or an apparatus of a target network node, in accordance with the present disclosure. Example process 900 is an example where the apparatus or the target network node (e.g., target network node 110) performs operations associated with data packet discard reduction for handover procedures.

As shown in FIG. 9, in some aspects, process 900 may include receiving, from a source network node, an indication of a set of PDUs scheduled for transmission to a UE (block 910). For example, the target network node (e.g., using reception component 1102 and/or communication manager 1106, depicted in FIG. 11) may receive, from a source network node, an indication of a set of PDUs scheduled for transmission to a UE, as described above.

As further shown in FIG. 9, in some aspects, process 900 may include receiving, from the UE after handover of the UE from the source network node to the target network node, information associated with a PDU in the set of PDUs scheduled for transmission to the UE based at least in part on a timer associated with the PDU and a request to discard a first subset PDUs of the set of PDUs based at least in part on the information (block 920). For example, the target network node (e.g., using reception component 1102 and/or communication manager 1106, depicted in FIG. 11) may receive, from the UE after handover of the UE from the source network node to the target network node, information associated with a PDU in the set of PDUs scheduled for transmission to the UE based at least in part on a timer associated with the PDU and a request to discard a first subset PDUs of the set of PDUs based at least in part on the information, as described above.

As further shown in FIG. 9, in some aspects, process 900 may include transmitting, to the UE, a second subset of PDUs of the set of PDUs based at least in part on the information (block 930). For example, the target network node (e.g., using transmission component 1104 and/or communication manager 1106, depicted in FIG. 11) may transmit, to the UE, a second subset of PDUs of the set of PDUs based at least in part on the information, as described above.

Process 900 may include additional aspects, such as any single aspect or any combination of aspects described below and/or in connection with one or more other processes described elsewhere herein.

In a first aspect, process 900 includes receiving, from the source network node, capability information indicating support by the UE for a scheme for reducing discarded PDUs after handover, wherein receiving the request to discard the first subset of PDUs based at least in part on the information associated with the PDU is in accordance with the scheme.

In a second aspect, alone or in combination with the first aspect, the information associated with the PDU includes a sequence number associated with the PDU based at least in part on a state of the timer.

In a third aspect, alone or in combination with one or more of the first and second aspects, process 900 includes determining, for the set of PDUs, a respective plurality of predicted timers based at least in part on the sequence number of the PDU and the state of the timer, discarding the first subset of PDUs based at least in part on the first subset of PDUs being associated with a respective first plurality of predicted timers are associated with a respective predicted expiration that does not satisfy a threshold, and transmitting the second subset of PDUs based at least in part on the second subset of PDUs being associated with a respective second plurality of predicted timers are associated with a respective predicted expiration that satisfies the threshold.

In a fourth aspect, alone or in combination with one or more of the first through third aspects, discarding the first subset of PDUs comprises transmitting, to the source network node, a request for the source network node to not forward the first subset of PDUs.

In a fifth aspect, alone or in combination with one or more of the first through fourth aspects, the state of the timer is expired.

In a sixth aspect, alone or in combination with one or more of the first through fifth aspects, the state of the timer is a remaining time failing to satisfy a threshold.

In a seventh aspect, alone or in combination with one or more of the first through sixth aspects, the threshold is associated with a latency parameter that is associated with an application, and wherein the application is associated with the set of PDUs scheduled for transmission to the UE.

In an eighth aspect, alone or in combination with one or more of the first through seventh aspects, the information associated with PDU and the request for the target network node to discard a first subset PDUs are received via RRC signaling that indicates the handover is complete.

In a ninth aspect, alone or in combination with one or more of the first through eighth aspects, the information associated with PDU and the request for the target network node to discard a first subset PDUs are received via a MAC-CE.

In a tenth aspect, alone or in combination with one or more of the first through ninth aspects, the handover is a layer 3 handover procedure, an LTM procedure, a CHO procedure, a sequence handover procedure, or a non-sequence handover procedure.

Although FIG. 9 shows example blocks of process 900, in some aspects, process 900 may include additional blocks, fewer blocks, different blocks, or differently arranged blocks than those depicted in FIG. 9. Additionally, or alternatively, two or more of the blocks of process 900 may be performed in parallel.

FIG. 10 is a diagram of an example apparatus 1000 for wireless communication, in accordance with the present disclosure. The apparatus 1000 may be a UE, or a UE may include the apparatus 1000. In some aspects, the apparatus 1000 includes a reception component 1002, a transmission component 1004, and/or a communication manager 1006, which may be in communication with one another (for example, via one or more buses and/or one or more other components). In some aspects, the communication manager 1006 is the communication manager 150 described in connection with FIG. 1. As shown, the apparatus 1000 may communicate with another apparatus 1008, such as a UE or a network node (such as a CU, a DU, an RU, or a base station), using the reception component 1002 and the transmission component 1004. The communication manager 1006 may be included in, or implemented via, a processing system (for example, the processing system 140 described in connection with FIG. 1) of the UE.

In some aspects, the apparatus 1000 may be configured to perform one or more operations described herein in connection with FIGS. 3 through 7. Additionally, or alternatively, the apparatus 1000 may be configured to perform one or more processes described herein, such as process 800 of FIG. 8. In some aspects, the apparatus 1000 and/or one or more components shown in FIG. 10 may include one or more components of the UE described in connection with FIG. 1. Additionally, or alternatively, one or more components shown in FIG. 10 may be implemented within one or more components described in connection with FIG. 1. Additionally, or alternatively, one or more components of the set of components may be implemented at least in part as software stored in one or more memories. For example, a component (or a portion of a component) may be implemented as instructions or code stored in a non-transitory computer-readable medium and executable by one or more controllers or one or more processors to perform the functions or operations of the component.

The reception component 1002 may receive communications, such as reference signals, control information, data communications, or a combination thereof, from the apparatus 1008. The reception component 1002 may provide received communications to one or more other components of the apparatus 1000. In some aspects, the reception component 1002 may perform signal processing on the received communications, and may provide the processed signals to the one or more other components of the apparatus 1000. In some aspects, the reception component 1002 may include one or more components of the UE described above in connection with FIG. 1, such as a radio, one or more RF chains, one or more transceivers, or one or more modems, each of which may in turn be coupled with one or more antennas of the UE.

The transmission component 1004 may transmit communications, such as reference signals, control information, data communications, or a combination thereof, to the apparatus 1008. In some aspects, one or more other components of the apparatus 1000 may generate communications and may provide the generated communications to the transmission component 1004 for transmission to the apparatus 1008. In some aspects, the transmission component 1004 may perform signal processing on the generated communications, and may transmit the processed signals to the apparatus 1008. In some aspects, the transmission component 1004 may include one or more components of the UE described above in connection with FIG. 1, such as a radio, one or more RF chains, one or more transceivers, or one or more modems, each of which may in turn be coupled with one or more antennas of the UE described in connection with FIG. 1. In some aspects, the transmission component 1004 may be co-located with the reception component 1002.

The communication manager 1006 may support operations of the reception component 1002 and/or the transmission component 1004. For example, the communication manager 1006 may receive information associated with configuring reception of communications by the reception component 1002 and/or transmission of communications by the transmission component 1004. Additionally, or alternatively, the communication manager 1006 may generate and/or provide control information to the reception component 1002 and/or the transmission component 1004 to control reception and/or transmission of communications.

The reception component 1002 may receive, from a source network node, information associated with a handover from the source network node to a target network node. The transmission component 1004 may transmit, to the target network node after the handover from the source network node to the target network node, information associated with a PDU in a set of PDUs scheduled for transmission to the UE based at least in part on a timer associated with the PDU and a request for the target network node to discard a first subset PDUs of the set of PDUs based at least in part on the information associated with the PDU. The reception component 1002 may receive, from the target network node, a second subset of PDUs of the set of PDUs based at least in part on the information.

The transmission component 1004 may transmit, to the source network node, capability information indicating support for a scheme for reducing discarded PDUs after handover, wherein transmitting the request for the target network node to discard the first subset of PDUs based at least in part on the information associated with the PDU is in accordance with the scheme.

The communication manager 1006 may store the second subset of PDUs, wherein the second subset of PDUs are associated with a respective plurality of timers that are not expired based at least in part on transmitting the information associated with the PDU.

The number and arrangement of components shown in FIG. 10 are provided as an example. In practice, there may be additional components, fewer components, different components, or differently arranged components than those shown in FIG. 10. Furthermore, two or more components shown in FIG. 10 may be implemented within a single component, or a single component shown in FIG. 10 may be implemented as multiple, distributed components. Additionally, or alternatively, a set of (one or more) components shown in FIG. 10 may perform one or more functions described as being performed by another set of components shown in FIG. 10.

FIG. 11 is a diagram of an example apparatus 1100 for wireless communication, in accordance with the present disclosure. The apparatus 1100 may be a target network node, or a target network node may include the apparatus 1100. In some aspects, the apparatus 1100 includes a reception component 1102, a transmission component 1104, and/or a communication manager 1106, which may be in communication with one another (for example, via one or more buses and/or one or more other components). In some aspects, the communication manager 1106 is the communication manager 155 described in connection with FIG. 1. As shown, the apparatus 1100 may communicate with another apparatus 1108, such as a UE or a network node (such as a CU, a DU, an RU, or a base station), using the reception component 1102 and the transmission component 1104. The communication manager 1106 may be included in, or implemented via, a processing system (for example, the processing system 145 described in connection with FIG. 1) of the target network node.

In some aspects, the apparatus 1100 may be configured to perform one or more operations described herein in connection with FIGS. 3 through 7. Additionally, or alternatively, the apparatus 1100 may be configured to perform one or more processes described herein, such as process 900 of FIG. 9. In some aspects, the apparatus 1100 and/or one or more components shown in FIG. 11 may include one or more components of the target network node described in connection with FIG. 1. Additionally, or alternatively, one or more components shown in FIG. 11 may be implemented within one or more components described in connection with FIG. 1. Additionally, or alternatively, one or more components of the set of components may be implemented at least in part as software stored in one or more memories. For example, a component (or a portion of a component) may be implemented as instructions or code stored in a non-transitory computer-readable medium and executable by one or more controllers or one or more processors to perform the functions or operations of the component.

The reception component 1102 may receive communications, such as reference signals, control information, data communications, or a combination thereof, from the apparatus 1108. The reception component 1102 may provide received communications to one or more other components of the apparatus 1100. In some aspects, the reception component 1102 may perform signal processing on the received communications, and may provide the processed signals to the one or more other components of the apparatus 1100. In some aspects, the reception component 1102 may include one or more components of the target network node described above in connection with FIG. 1, such as a radio, one or more RF chains, one or more transceivers, or one or more modems, each of which may in turn be coupled with one or more antennas of the target network node. In some aspects, the reception component 1102 and/or the transmission component 1104 may include or may be included in a network interface. The network interface may be configured to obtain and/or output signals for the apparatus 1100 via one or more communications links, such as a backhaul link, a midhaul link, and/or a fronthaul link.

The transmission component 1104 may transmit communications, such as reference signals, control information, data communications, or a combination thereof, to the apparatus 1108. In some aspects, one or more other components of the apparatus 1100 may generate communications and may provide the generated communications to the transmission component 1104 for transmission to the apparatus 1108. In some aspects, the transmission component 1104 may perform signal processing on the generated communications, and may transmit the processed signals to the apparatus 1108. In some aspects, the transmission component 1104 may include one or more components of the target network node described above in connection with FIG. 1, such as a radio, one or more RF chains, one or more transceivers, or one or more modems, each of which may in turn be coupled with one or more antennas of the target network node described in connection with FIG. 1. In some aspects, the transmission component 1104 may be co-located with the reception component 1102.

The communication manager 1106 may support operations of the reception component 1102 and/or the transmission component 1104. For example, the communication manager 1106 may receive information associated with configuring reception of communications by the reception component 1102 and/or transmission of communications by the transmission component 1104. Additionally, or alternatively, the communication manager 1106 may generate and/or provide control information to the reception component 1102 and/or the transmission component 1104 to control reception and/or transmission of communications.

The reception component 1102 may receive, from a source network node, an indication of a set of PDUs scheduled for transmission to a UE. The reception component 1102 may receive, from the UE after handover of the UE from the source network node to the target network node, information associated with a PDU in the set of PDUs scheduled for transmission to the UE based at least in part on a timer associated with the PDU and a request to discard a first subset PDUs of the set of PDUs based at least in part on the information. The transmission component 1104 may transmit, to the UE, a second subset of PDUs of the set of PDUs based at least in part on the information.

The reception component 1102 may receive, from the source network node, capability information indicating support by the UE for a scheme for reducing discarded PDUs after handover, wherein receiving the request to discard the first subset of PDUs based at least in part on the information associated with the PDU is in accordance with the scheme.

The communication manager 1106 may determine, for the set of PDUs, a respective plurality of predicted timers based at least in part on the sequence number of the PDU and the state of the timer.

The communication manager 1106 may discard the first subset of PDUs based at least in part on the first subset of PDUs being associated with a respective first plurality of predicted timers are associated with a respective predicted expiration that does not satisfy a threshold.

The transmission component 1104 may transmit the second subset of PDUs based at least in part on the second subset of PDUs being associated with a respective second plurality of predicted timers are associated with a respective predicted expiration that satisfies the threshold.

The number and arrangement of components shown in FIG. 11 are provided as an example. In practice, there may be additional components, fewer components, different components, or differently arranged components than those shown in FIG. 11. Furthermore, two or more components shown in FIG. 11 may be implemented within a single component, or a single component shown in FIG. 11 may be implemented as multiple, distributed components. Additionally, or alternatively, a set of (one or more) components shown in FIG. 11 may perform one or more functions described as being performed by another set of components shown in FIG. 11.

The following provides an overview of some Aspects of the present disclosure:

Aspect 1: A method of wireless communication performed by a UE, comprising: receiving, from a source network node, information associated with a handover from the source network node to a target network node; transmitting, to the target network node after the handover from the source network node to the target network node, information associated with a protocol data unit (PDU) in a set of PDUs scheduled for transmission to the UE based at least in part on a timer associated with the PDU and a request for the target network node to discard a first subset PDUs of the set of PDUs based at least in part on the information associated with the PDU; and receiving, from the target network node, a second subset of PDUs of the set of PDUs based at least in part on the information.

Aspect 2: The method of Aspect 1, further comprising: transmitting, to the source network node, capability information indicating support for a scheme for reducing discarded PDUs after handover, wherein transmitting the request for the target network node to discard the first subset of PDUs based at least in part on the information associated with the PDU is in accordance with the scheme.

Aspect 3: The method of Aspect 2, wherein receiving the information associated with the handover from the source network node to the target network node comprises: receiving an indication to enable the scheme for reducing discarded PDUs after handover based at least in part on the capability information.

Aspect 4: The method of any of Aspects 1-3, wherein the information associated with the PDU includes a sequence number associated with the PDU based at least in part on a state of the timer.

Aspect 5: The method of Aspect 4, wherein the state of the timer is expired.

Aspect 6: The method of Aspect 4, wherein the state of the timer is a remaining time failing to satisfy a threshold.

Aspect 7: The method of Aspect 6, wherein the threshold is associated with a latency parameter that is associated with an application, and wherein the application is associated with the set of PDUs scheduled for transmission to the UE

Aspect 8: The method of any of Aspects 1-7, further comprising: storing the second subset of PDUs, wherein the second subset of PDUs are associated with a respective plurality of timers that are not expired based at least in part on transmitting the information associated with the PDU.

Aspect 9: The method of any of Aspects 1-8, wherein the information associated with PDU and the request for the target network node to discard a first subset PDUs are transmitted via radio resource control (RRC) signaling that indicates the handover is complete.

Aspect 10: The method of any of Aspects 1-9, wherein the information associated with PDU and the request for the target network node to discard a first subset PDUs are transmitted via a medium access control element (MAC-CE).

Aspect 11: The method of any of Aspects 1-10, wherein the handover is a layer 3 handover procedure, a layer 1 or layer 2 triggered mobility (LTM) procedure, a conditional handover (CHO) procedure, a sequence handover procedure, or a non-sequence handover procedure.

Aspect 12: A method of wireless communication performed by a target network node, comprising: receiving, from a source network node, an indication of a set of protocol data units (PDUs) scheduled for transmission to a UE; receiving, from the UE after handover of the UE from the source network node to the target network node, information associated with a PDU in the set of PDUs scheduled for transmission to the UE based at least in part on a timer associated with the PDU and a request to discard a first subset PDUs of the set of PDUs based at least in part on the information; and transmitting, to the UE, a second subset of PDUs of the set of PDUs based at least in part on the information.

Aspect 13: The method of Aspect 12, further comprising: receiving, from the source network node, capability information indicating support by the UE for a scheme for reducing discarded PDUs after handover, wherein receiving the request to discard the first subset of PDUs based at least in part on the information associated with the PDU is in accordance with the scheme.

Aspect 14: The method of any of Aspects 12-13, wherein the information associated with the PDU includes a sequence number associated with the PDU based at least in part on a state of the timer.

Aspect 15: The method of Aspect 14, further comprising: determining, for the set of PDUs, a respective plurality of predicted timers based at least in part on the sequence number of the PDU and the state of the timer; discarding the first subset of PDUs based at least in part on the first subset of PDUs being associated with a respective first plurality of predicted timers are associated with a respective predicted expiration that does not satisfy a threshold; and transmitting the second subset of PDUs based at least in part on the second subset of PDUs being associated with a respective second plurality of predicted timers are associated with a respective predicted expiration that satisfies the threshold.

Aspect 16: The method of Aspect 15, wherein discarding the first subset of PDUs comprises: transmitting, to the source network node, a request for the source network node to not forward the first subset of PDUs.

Aspect 17: The method of Aspect 14, wherein the state of the timer is expired.

Aspect 18: The method of Aspect 14, wherein the state of the timer is a remaining time failing to satisfy a threshold.

Aspect 19: The method of Aspect 18, wherein the threshold is associated with a latency parameter that is associated with an application, and wherein the application is associated with the set of PDUs scheduled for transmission to the UE.

Aspect 20: The method of any of Aspects 12-19, wherein the information associated with PDU and the request for the target network node to discard a first subset PDUs are received via radio resource control (RRC) signaling that indicates the handover is complete.

Aspect 21: The method of any of Aspects 12-20, wherein the information associated with PDU and the request for the target network node to discard a first subset PDUs are received via a medium access control element (MAC-CE).

Aspect 22: The method of any of Aspects 12-21, wherein the handover is a layer 3 handover procedure, a layer 1 or layer 2 triggered mobility (LTM) procedure, a conditional handover (CHO) procedure, a sequence handover procedure, or a non-sequence handover procedure.

Aspect 23: An apparatus for wireless communication at a device, the apparatus comprising one or more processors; one or more memories coupled with the one or more processors; and instructions stored in the one or more memories and executable by the one or more processors to cause the apparatus to perform the method of one or more of Aspects 1-22.

Aspect 24: An apparatus for wireless communication at a device, the apparatus comprising one or more memories and one or more processors coupled to the one or more memories, the one or more processors configured to cause the device to perform the method of one or more of Aspects 1-22.

Aspect 25: An apparatus for wireless communication, the apparatus comprising at least one means for performing the method of one or more of Aspects 1-22.

Aspect 26: A non-transitory computer-readable medium storing code for wireless communication, the code comprising instructions executable by one or more processors to perform the method of one or more of Aspects 1-22.

Aspect 27: A non-transitory computer-readable medium storing a set of instructions for wireless communication, the set of instructions comprising one or more instructions that, when executed by one or more processors of a device, cause the device to perform the method of one or more of Aspects 1-22.

Aspect 28: A device for wireless communication, the device comprising a processing system that includes one or more processors and one or more memories coupled with the one or more processors, the processing system configured to cause the device to perform the method of one or more of Aspects 1-22.

Aspect 29: An apparatus for wireless communication at a device, the apparatus comprising one or more memories and one or more processors coupled to the one or more memories, the one or more processors individually or collectively configured to cause the device to perform the method of one or more of Aspects 1-22.

The foregoing disclosure provides illustration and description but is not intended to be exhaustive or to limit the aspects to the precise forms disclosed. Modifications and variations may be made in light of the above disclosure or may be acquired from practice of the aspects. No element, act, or instruction described herein should be construed as critical or essential unless explicitly described as such.

It will be apparent that systems or methods described herein may be implemented in different forms of hardware or a combination of hardware and software. The actual specialized control hardware or software used to implement these systems or methods is not limiting of the aspects. Thus, the operation and behavior of the systems or methods are described herein without reference to specific software code, because those skilled in the art will understand that software and hardware can be designed to implement the systems or methods based, at least in part, on the description herein. A component being configured to perform a function means that the component has a capability to perform the function, and does not require the function to be actually performed by the component, unless noted otherwise.

As used herein, the articles “a” and “an” are intended to refer to one or more items and may be used interchangeably with “one or more” or “at least one.” Further, as used herein, the article “the” is intended to include one or more items referenced in connection with the article “the” and may be used interchangeably with “the one or more.” Furthermore, as used herein, the terms “set” and “group” are intended to include one or more items and may be used interchangeably with “one or more.” Where only one item is intended, the phrase “only one” or “a single one” or similar language is used. Also, as used herein, the terms “has,” “have,” “having,” “comprise,” “comprising,” “include” and “including,” and derivatives thereof or similar terms are intended to be open-ended terms that do not limit an element that they modify (for example, an element “having” A may also have B). Also, as used herein, the term “or” is intended to be inclusive when used in a series and may be used interchangeably with “and/or,” unless explicitly stated otherwise (for example, if used in combination with “either” or “only one of”). As used herein, a phrase referring to “at least one of” a list of items refers to any combination of those items, including single members. As an example, “at least one of: a, b, or c” is intended to cover a, b, c, a + b, a + c, b + c, and a + b + c, as well as any combination with multiples of the same element (for example, a + a, a + a + a, a + a + b, a + a + c, a + b + b, a + c + c, b + b, b + b + b, b + b + c, c + c, and c + c + c, or any other ordering of a, b, and c).

As used herein, the term “determine” or “determining” encompasses a wide variety of actions and, therefore, “determining” can include calculating, computing, processing, deriving, estimating, investigating, looking up (such as via looking up in a table, a database, or another data structure), searching, inferring, ascertaining, and/or measuring, among other possibilities. Also, “determining” can include receiving (such as receiving information), accessing (such as accessing data stored in memory) or transmitting (such as transmitting information), among other possibilities. Additionally, “determining” can include resolving, selecting, obtaining, choosing, establishing, and/or other such similar actions.

As used herein, the phrase “based on” is intended to mean “based at least in part on” or “based on or otherwise in association with” unless explicitly stated otherwise. As used herein, “satisfying a threshold” may, depending on the context, refer to a value being greater than the threshold, greater than or equal to the threshold, less than the threshold, less than or equal to the threshold, equal to the threshold, or not equal to the threshold, among other examples.

Even though particular combinations of features are recited in the claims or disclosed in the specification, these combinations are not intended to limit the scope of all aspects described herein. Many of these features may be combined in ways not specifically recited in the claims or disclosed in the specification. The disclosure of various aspects includes each dependent claim in combination with every other claim in the claim set.

What is claimed is:

1. A user equipment (UE) for wireless communication, comprising:
one or more memories; and
one or more processors, coupled to the one or more memories, configured to cause the UE to:
receive, from a source network node, information associated with a handover from the source network node to a target network node;
transmit, to the target network node after the handover from the source network node to the target network node, information associated with a protocol data unit (PDU) in a set of PDUs scheduled for transmission to the UE based at least in part on a timer associated with the PDU and a request for the target network node to discard a first subset PDUs of the set of PDUs based at least in part on the information associated with the PDU; and
receive, from the target network node, a second subset of PDUs of the set of PDUs based at least in part on the information.

2. The UE of claim 1, wherein the one or more processors are further configured to cause the UE to:
transmit, to the source network node, capability information indicating support for a scheme for reducing discarded PDUs after handover, wherein transmitting the request for the target network node to discard the first subset of PDUs based at least in part on the information associated with the PDU is in accordance with the scheme.

3. The UE of claim 2, wherein the one or more processors, to cause the UE to receive the information associated with the handover from the source network node to the target network node, are configured to cause the UE to:
receive an indication to enable the scheme for reducing discarded PDUs after handover based at least in part on the capability information.

4. The UE of claim 1, wherein the information associated with the PDU includes a sequence number associated with the PDU based at least in part on a state of the timer.

5. The UE of claim 4, wherein the state of the timer is expired.

6. The UE of claim 4, wherein the state of the timer is a remaining time failing to satisfy a threshold.

7. The UE of claim 6, wherein the threshold is associated with a latency parameter that is associated with an application, and wherein the application is associated with the set of PDUs scheduled for transmission to the UE.

8. The UE of claim 1, wherein the one or more processors are further configured to cause the UE to:
store the second subset of PDUs, wherein the second subset of PDUs are associated with a respective plurality of timers that are not expired based at least in part on transmitting the information associated with the PDU.

9. The UE of claim 1, wherein the information associated with PDU and the request for the target network node to discard a first subset PDUs are transmitted via radio resource control (RRC) signaling that indicates the handover is complete.

10. The UE of claim 1, wherein the information associated with PDU and the request for the target network node to discard a first subset PDUs are transmitted via a medium access control element (MAC-CE).

11. The UE of claim 1, wherein the handover is a layer 3 handover procedure, a layer 1 or layer 2 triggered mobility (LTM) procedure, a conditional handover (CHO) procedure, a sequence handover procedure, or a non-sequence handover procedure.

12. A method of wireless communication performed by a user equipment (UE), comprising:
receiving, from a source network node, information associated with a handover from the source network node to a target network node;
transmitting, to the target network node after the handover from the source network node to the target network node, information associated with a protocol data unit (PDU) in a set of PDUs scheduled for transmission to the UE based at least in part on a timer associated with the PDU and a request for the target network node to discard a first subset PDUs of the set of PDUs based at least in part on the information associated with the PDU; and
receiving, from the target network node, a second subset of PDUs of the set of PDUs based at least in part on the information.

13. The method of claim 12, further comprising:
transmitting, to the source network node, capability information indicating support for a scheme for reducing discarded PDUs after handover, wherein transmitting the request for the target network node to discard the first subset of PDUs based at least in part on the information associated with the PDU is in accordance with the scheme.

14. The method of claim 13, wherein receiving the information associated with the handover from the source network node to the target network node comprises:
receiving an indication to enable the scheme for reducing discarded PDUs after handover based at least in part on the capability information.

15. The method of claim 12, wherein the information associated with the PDU includes a sequence number associated with the PDU based at least in part on a state of the timer.

16. The method of claim 15, wherein the state of the timer is expired.

17. The method of claim 15, wherein the state of the timer is a remaining time failing to satisfy a threshold.

18. The method of claim 17, wherein the threshold is associated with a latency parameter that is associated with an application, and wherein the application is associated with the set of PDUs scheduled for transmission to the UE.

19. The method of claim 12, further comprising:
storing the second subset of PDUs, wherein the second subset of PDUs are associated with a respective plurality of timers that are not expired based at least in part on transmitting the information associated with the PDU.

20. A non-transitory computer-readable medium storing a set of instructions for wireless communication, the set of instructions comprising:
one or more instructions that, when executed by one or more processors of a user equipment (UE), cause the UE to:
receive, from a source network node, information associated with a handover from the source network node to a target network node;
transmit, to the target network node after the handover from the source network node to the target network node, information associated with a protocol data unit (PDU) in a set of PDUs scheduled for transmission to the UE based at least in part on a timer associated with the PDU and a request for the target network node to discard a first subset PDUs of the set of PDUs based at least in part on the information associated with the PDU; and
receive, from the target network node, a second subset of PDUs of the set of PDUs based at least in part on the information.
